(19) United States
(12) Patent Application Publication
(10) Pub. No.: US 2026/0020075 A1
(43) Pub. Date: Jan. 15, 2026

(54) METHOD AND APPARATUS FOR RANDOM ACCESS RESOURCE CONFIGURATION IN A WIRELESS COMMUNICATION SYSTEM

(71) Applicant: ASUS Technology Licensing Inc., Taipei City (TW)

(72) Inventors: Wei-Han Lai, Taipei City (TW); Yu-Hsuan Guo, Taipei City (TW)

(21) Appl. No.: 19/261,873

(22) Filed: Jul. 7, 2025

Related U.S. Application Data
(60) Provisional application No. 63/669,169, filed on Jul. 9, 2024.
(60) Provisional application No. 63/672,147, filed on Jul. 16, 2024.

(51) Int. Cl. H04W 74/0833; H04W 72/21

(52) U.S. Cl. CPC H04W 74/0833; H04W 72/21

(57) ABSTRACT

Methods, systems, and apparatuses are provided for Random Access (RA) resource configurations in a wireless communication system, wherein a method for a UE comprises receiving a first configuration of random access at least for User Equipments (UEs) supporting Physical Random Access Channel (PRACH) adaptation in time domain and not for UEs not supporting PRACH adaptation in time domain, wherein the UE derives a first set of one or more PRACH occasions based on the first configuration, receiving a second configuration of random access at least for the UEs not supporting PRACH adaptation in time domain, wherein the UE derives a second set of one or more PRACH occasions based on the second configuration, selecting a first PRACH occasion among multiple PRACH occasions, wherein whether the multiple PRACH occasions can include a PRACH occasion from the first set of one or more PRACH occasions is based on at least a purpose of a random access procedure, and performing a first transmission on the first PRACH occasion during the random access procedure.

### CROSS-REFERENCE TO RELATED APPLICATIONS

The present application claims priority to and the benefit of U.S. Provisional Patent Application Ser. No. 63/669,169, filed Jul. 9, 2024, and U.S. Provisional Patent Application Ser. No. 63/672,147, filed Jul. 16, 2024; with each of the referenced and listed applications and disclosures hereby fully incorporated herein by reference.

### FIELD

This disclosure generally relates to wireless communication networks and, more particularly, to a method and apparatus for random access resource configuration in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for Random Access (RA) resource configurations in a wireless communication system such that RA resources for time-domain adaptation could be configured properly to reduce overhead.

In various embodiments, a method for a UE in a wireless communication system comprises receiving a first configuration of random access at least for User Equipments (UEs) supporting PRACH adaptation in time domain and not for UEs not supporting Physical Random Access Channel (PRACH) adaptation in time domain, wherein the UE derives a first set of one or more PRACH occasions based on the first configuration, receiving a second configuration of random access at least for the UEs not supporting PRACH adaptation in time domain, wherein the UE derives a second set of one or more PRACH occasions based on the second configuration, selecting a first PRACH occasion among multiple PRACH occasions, wherein whether the multiple PRACH occasions can include a PRACH occasion from the first set of one or more PRACH occasions is based on at least a purpose of a random access procedure, and performing a first transmission on the first PRACH occasion during the random access procedure.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5A is a reproduction of FIG. 9.2.6-1: Random Access Procedures—(a) CBRA with 4-step RA type, from 3GPP TS 38.300 V18.1.0.

FIG. 5B is a reproduction of FIG. 9.2.6-1: Random Access Procedures—(b) CBRA with 2-step RA type, from 3GPP TS 38.300 V18.1.0.

FIG. 5C is a reproduction of FIG. 9.2.6-1: Random Access Procedures—(c) CFRA with 4-step RA type, from 3GPP TS 38.300 V18.1.0.

FIG. 5D is a reproduction of FIG. 9.2.6-1: Random Access Procedures—(d) CFRA with 2-step RA type, from 3GPP TS 38.300 V18.1.0.

FIG. 5E is a reproduction of FIG. 9.2.6-1: Random Access Procedures—(e) CFRA without network response with 4-step RA type, from 3GPP TS 38.300 V18.1.0.

FIG. 6 is a reproduction of FIG. 9.2.6-2: Fallback for CBRA with 2-step RA type, from 3GPP TS 38.300 V18.1.0.

FIG. 7 is a reproduction of FIG. 6.1.5-1: E/T/R/R/BI MAC subheader, from 3GPP TS 38.321 V18.1.0.

FIG. 8 is a reproduction of FIG. 6.1.5-2: ET/RAPID MAC subheader, from 3GPP TS 38.321 V18.1.0.

FIG. 9 is a reproduction of FIG. 6.1.5-3: Example of MAC PDU consisting of MAC RARs, from 3GPP TS 38.321 V18.1.0.

FIG. 10 is a reproduction of FIG. 6.1.5a-1: BI MAC subheader, from 3GPP TS 38.321 V18.1.0.

FIG. 11 is a reproduction of FIG. 6.1.5a-2: FallbackRAR MAC subheader, from 3GPP TS 38.321 V18.1.0.

FIG. 12 is a reproduction of FIG. 6.1.5a-3: SuccessRAR MAC subheader, from 3GPP TS 38.321 V18.1.0.

FIG. 13 is a reproduction of FIG. 6.1.5a-4: Example of a MSGB MAC PDU with MAC SDU(s), from 3GPP TS 38.321 V18.1.0.

FIG. 14 is a reproduction of FIG. 6.1.5a-5: Example of a MSGB MAC PDU without MAC SDU(s), from 3GPP TS 38.321 V18.1.0.

FIG. 15A is an example diagram showing the current implementation of a RO may result in long turn-on duration for the cell, in accordance with embodiments of the present invention.

FIG. 15B is an example diagram showing that the adaptation based on additional PRACH resources offers the cell with an opportunity to enter dormancy when there is no PRACH resource provided (e.g., within a time duration), in accordance with embodiments of the present invention.

FIG. 16 is an example diagram showing the preamble(s) for legacy UEs and the preamble(s) for NES UEs may be different (e.g., legacy UE may apply legacy preamble(s)), in accordance with embodiments of the present invention.

FIG. 17A is an example diagram showing the WUS start index configuration, in accordance with embodiments of the present invention.

FIG. 17B is an example diagram showing the WUS end index configuration, in accordance with embodiments of the present invention.

FIG. 17C is an example diagram showing the WUS end index configuration, in accordance with embodiments of the present invention.

FIG. 17D is an example diagram showing the WUS start index configuration, in accordance with embodiments of the present invention.

FIG. 17E is an example diagram showing the WUS start index configuration, in accordance with embodiments of the present invention.

FIG. 18A is an example diagram showing that the WUS for SSB request and the WUS for SIB1 request may be both configured, in accordance with embodiments of the present invention.

FIG. 18B is an example diagram showing that the WUS for SSB request and the WUS for SIB1 request may be both configured, in accordance with embodiments of the present invention.

FIG. 18C is an example diagram showing that the WUS for SSB request and the WUS for SIB1 request may be both configured, in accordance with embodiments of the present invention.

FIG. 18D is an example diagram showing that the WUS for SSB request and the WUS for SIB1 request may be both configured, in accordance with embodiments of the present invention.

FIG. 19 is a flow diagram of a method of a first UE in a wireless communication system comprising determining or deriving (at least) a first configuration by a first method, determining or deriving (at least) a second configuration by a second method, and selecting a resource to perform a transmission based on a first factor.

FIG. 20A is an example diagram showing that a legacy UE (UE1) and an NES UE (UE2) both select a legacy RO (L1) to perform Msg1 transmission, in accordance with embodiments of the present invention.

FIG. 20B is an example diagram showing that a legacy UE (UE1) selects a legacy RO (L1), and an NES UE (UE2) selects an additional RO (A1) to perform Msg1 transmission, in accordance with embodiments of the present invention.

FIG. 21 is an example diagram showing that a first scaling factor may not be configured (in a second configuration) to a legacy UE (UE1) since the random access (on UE1) is not prioritized, in accordance with embodiments of the present invention.

FIG. 22A is an example diagram showing that if UE1 and UE2 derive different RA-RNTIs, UE1 and UE2 may receive different RAR corresponding to each RA-RNTI, in accordance with embodiments of the present invention.

FIG. 22B is an example diagram showing that the RAR may include (one or more) BI fields and may not include a corresponding RAPID (corresponding to preamble selected by either UE1 or UE2), in accordance with embodiments of the present invention.

FIG. 22C is an example diagram showing that the RAR may include (one or more) BI fields and may not include a corresponding RAPID (corresponding to preamble selected by either UE1 or UE2), in accordance with embodiments of the present invention.

FIG. 23 is a flow diagram of a method of a UE in a wireless communication system comprising determining or deriving (at least) a configuration by a method, performing a first transmission, starting a timer, receiving one or more responses from a network, deciding whether to perform a second transmission based on a condition, and performing the second transmission at a time based on a factor.

FIG. 24 is a flow diagram of a method of a UE in a wireless communication system comprising determining or deriving (at least) a configuration by a method, performing a first transmission, deriving a first ID based on a first factor, starting a timer, receiving one or more responses from a network based on a first condition, deciding whether to perform a second transmission based on a second condition, and performing the second transmission at a time based on a second factor.

FIG. 25 is a flow diagram of a method of a UE in a wireless communication system comprising receiving a first configuration of random access at least for UEs supporting PRACH adaptation in time domain and not for UEs not supporting PRACH adaptation in time domain, receiving a second configuration of random access at least for UEs not supporting PRACH adaptation in time domain, selecting a first PRACH occasion among multiple PRACH occasions, and performing a first transmission on the first PRACH occasion during the random access procedure.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-234065, “New WID: Enhancements of network energy savings for NR”; [2] Final Report of 3GPP TSG RAN WG1 #116b v1.0.0 (Changsha, China, Apr. 15-19, 2024); [3] Draft Report of 3GPP TSG RAN WG1 #117 v0.2.0 (Fukuoka, Japan, May 20-24, 2024); [4] 3GPP TS 38.300 V18.1.0 (2024-03) 3GPP; TSG RAN; NR; NR and NG-RAN Overall Description (Release 18); [5] 3GPP TS 38.321 V18.1.0 (2024-03) 3GPP; TSG RAN; NR; MAC protocol specification (Release 18); and [6] 3GPP TS 38.331 V18.1.0 (2024-03) 3GPP; TSG RAN; NR; RRC protocol specification (Release 18). The standards and documents listed above are hereby expressly and fully incorporated herein by reference in their entirety.

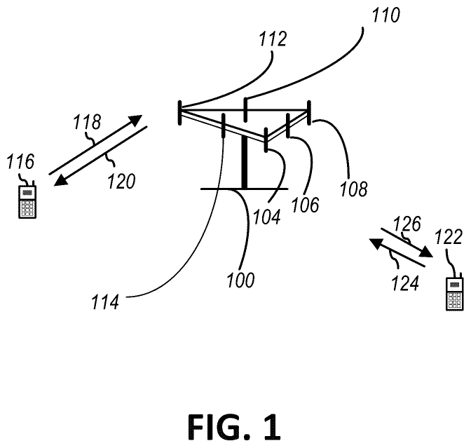

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

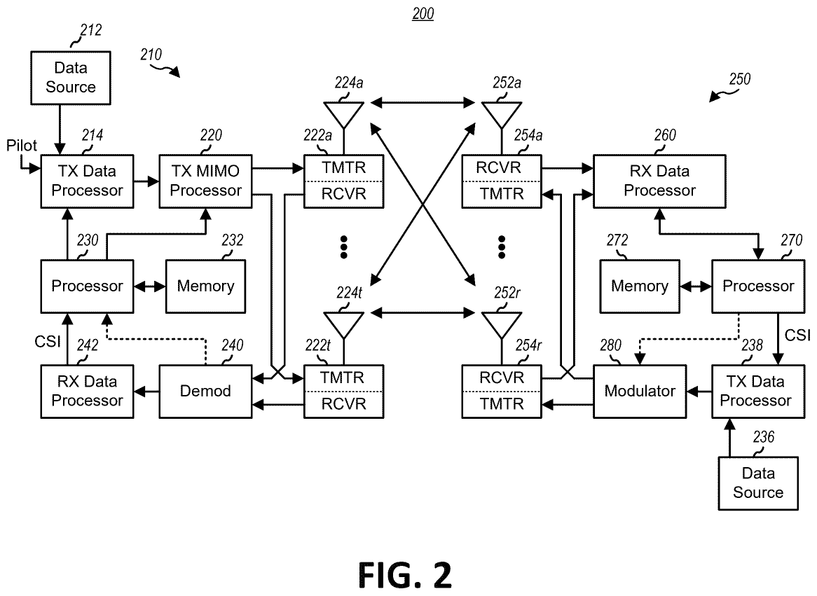

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

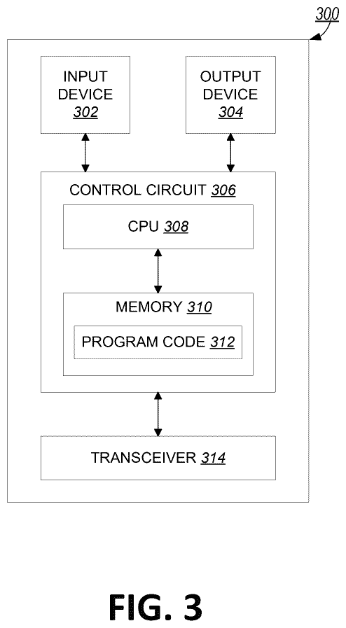

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

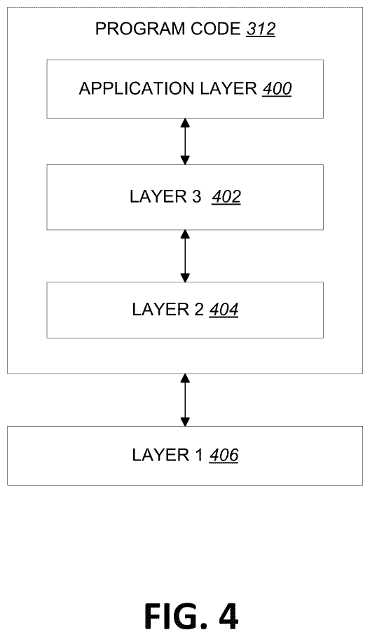

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

The study item of Enhancements of network energy savings (NES) has been approved in the RAN plenary #102 meeting. The description is specified in [1] RP-234065 as below:

### **************************************Quotation Start [1]**************************************

### 3 Justification

Network energy saving is of great importance for environmental sustainability, to reduce environmental impact (greenhouse gas emissions), and for operational cost savings. As 5G is becoming pervasive across industries and geographical areas, handling more advanced services and applications requiring very high data rates (e.g. XR), networks are being denser, use more antennas, larger bandwidths and more frequency bands. The environmental impact of 5G needs to stay under control, and novel solutions to improve network energy savings need to be developed.

Energy consumption has become a key part of the operators' OPEX. According to the report from GSMA, the energy cost on mobile networks accounts for ˜23% of the total operator cost. Most of the energy consumption comes from the radio access network and in particular from the Active Antenna Unit (AAU), with data centres and fibre transport accounting for a smaller share. The power consumption of a radio access can be split into two parts: the dynamic part which is only consumed when data transmission/reception is ongoing, and the static part which is consumed all the time to maintain the necessary operation of the radio access devices, even when the data transmission/reception is not on-going.

During the study in the SI phase, the network energy consumption model for the base station (BS) was defined including the reference configurations for FR1 TDD/FDD and FR2, the deep/light/micro sleep power states with corresponding relative power, transition time and energy consumption among different power states based on two types of BS categories, and the scaling rules for the active DL/UL power states considering BS power split by a static part of power and a dynamic part of power with the latter part reflecting the dynamic power consumption with respect to transmission/reception resource configurations in time, frequency, spatial and power domains. In addition, evaluation methodology and assumptions were achieved to study and evaluate the network energy saving gains for potential techniques with respect to other KPI including UPT, access delay, UE power consumption, etc.

Based on the agreed BS energy consumption model, and the evaluation methodology and assumptions, potential network energy saving techniques in various domains were evaluated with respect to the energy saving gains and the corresponding performance impact considering the above KPIs. The studied techniques are classified into time, frequency, spatial and power domains, and the technical descriptions as well as the legacy UE and specification impacts are summarized in the technical report. The techniques in time and frequency domains mainly aim to reduce the power consumption for dynamic part by trying to shutdown more symbols on one or more carriers to achieve BS micro sleep, and even the static power part by enlarging the interval between the contiguous active transmission/reception occasions to achieve BS light/deep sleep. The techniques in spatial and power domains mainly aim to reduce the power consumption of the TRX chains and PAs by trying to shutdown more spatial elements and/or reduce transmission power/power spectum density, or increase the PA efficiency. As shown in Section 7 in TR 38.864, some of the studied techniques are beneficial for network energy savings.

The Rel-18 work item on network energy savings for NR led to the specification of some of the techniques that were found beneficial in the study, primarily for RRC Connected, user specific signals and channels, and low load scenarios. The techniques specified in Rel-18 include SSB-less SCell operation for inter-band CA for FR1 and co-located cells, enhancement on cell DTX/DRX mechanism including the alignment of cell DTX/DRX and UE DRX in RRC_CONNECTED mode, inter-node information exchange on cell DTX/DRX, techniques in spatial and power domains to enable efficient adaptation of spatial elements as well as efficient adaptation of power offset values between PDSCH and CSI-RS, as well as mechanisms to prevent legacy UEs camping on cells adopting the Rel-18 NES techniques, CHO procedure enhancement(s), and inter-node beam activation and enhancements on restricting paging in a limited area, and the corresponding RRM/RF core requirements.

Some other techniques also found to be beneficial in the study were not yet specified in Rel-18. This Rel-19 work item aims to specify further network energy savings targeting the beneficial techniques studied in Rel-18, but yet unspecified, including on-demand SSB and on-demand SIB1 transmissions, as well as adaptation of common signal/channel transmissions.

### 4 Objective

4.1 Objective of SI or Core part WI or Testing part WI

The objectives of the work item are the following:

. . .

3. Specify adaptation of common signal/channel transmissions. [RAN1/2/3/4]
Adaptation of SSB in time domain, e.g. adapting periodicity
Adaptation of PRACH in time domain
Study adaptation of PRACH in spatial domain, e.g. non-uniform PRACH resources per SSB, and specify if found beneficial
   This study is to be done in 2Q'2024 only
Adaptation of paging occasions including confining the paging occasions in the time domain
   Note: there shall be no paging latency increase
Note: there shall be no negative impact to legacy UEs, unless significant benefits are shown

### **************************************Quotation End**************************************

In the 3GPP RAN1 #116bis meeting ([2] Final Report of 3GPP TSG RAN WG1 #116b v1.0.0), there are some agreements on network energy saving focusing on adaptation of common signal/channel transmissions:

### **************************************Quotation Start [2]**************************************

### 9.5 Enhancements of Network Energy Savings for NR

### 9.5.3 Adaptation of Common Signal/Channel Transmissions

. . .

### R1-245.2 Summary #2 AI 9.5.3 for R19 NES Moderator (Ericsson)

For adaptation of PRACH in time-domain, support at least the following:
Adaptation based on additional PRACH resources for NES-capable UEs in addition to PRACH resources for legacy UEs (if any)
   Note: NES-capable UEs can use both additional PRACH resources and PRACH resources for legacy UEs
   Configuration of additional PRACH resources is provided by semi-static signalling
      FFS: details including whether there is overlap of additional PRACH resources and PRACH resources for legacy UEs
   FFS: adaptation mechanism for additional PRACH resources

For adaptation of PRACH in time-domain, support the following:
SSB-RO mapping for the additional PRACH resources is separate from the SSB-RO mapping of the PRACH resources for legacy UEs (if any)
   FFS: whether/how to handle SSB-RO mapping if the additional PRACH resources overlap in both time and frequency with the PRACH resources for legacy UEs
   Note: SSB-RO mapping of the PRACH resources for legacy UEs is not impacted if Rel-19 UE uses these PRACH resources
   FFS: SSB-RO mapping for the additional PRACH resources

Support adaptation mechanisms of PRACH in time-domain for following:
UE in idle/inactive mode
UE in connected mode

. . .

### **************************************Quotation End**************************************

In the 3GPP RAN1 #117 meeting ([3] Draft Report of 3GPP TSG RAN WG1 #117 v0.2.0), further agreements on network energy saving focusing on adaptation of common signal/channel transmissions are provided:

### **************************************Quotation Start [3]**********************************

### 9.5 Enhancements of Network Energy Savings for NR

### 9.5.3 Adaptation of Common Signal/Channel Transmissions

. . .

### R1-2405460 Summary #2 of AI 9.5.3 for R19 NES Moderator (Ericsson)

For adaptation of PRACH in time-domain, support at least the following case(s)
Case 1: no time-domain overlap between the additional PRACH resources for NES-capable UEs and the PRACH resources for legacy UEs
Case 2: time-domain overlap but no overlap in frequency domain between the additional PRACH resources for NES-capable UEs and the PRACH resources for legacy UEs
Case 3: additional PRACH resources for NES-capable UEs and legacy PRACH resources overlap neither in time nor frequency domains
FFS: whether additional conditions are needed to support the above cases
FFS: Additional case whether full/partial overlap in both time and frequency is allowed
Above does not preclude discussion for the case where the configuration for additional PRACH resources contains legacy PRACH resources

At least for the case where legacy ROs and additional ROs overlap in neither time nor frequency domain, for adaptation of PRACH in time-domain, the SSB-RO mapping rule for additional PRACH resources follows the legacy SSB-RO mapping rule.
Mapping SS/PBCH block indexes to valid additional PRACH occasions provided by semi-static signalling follows the legacy mapping order for preamble/time resource/frequency/PRACH slot indexes.
   Note: This mapping is not impacted by time domain PRACH adaptation
Validation rules for the additional PRACH resources follow the legacy validation rules for PRACH resources configured for legacy UEs.

. . .

### Proposal 3.1.3-Updated2

For adaptation of PRACH in time-domain, the additional PRACH resources are configured based on at least:
a PRACH configuration index
FFS: whether the PRACH configuration index is same and/or different from the PRACH configuration index for the legacy PRACH resources

Study further the following
When the PRACH configuration index for the additional PRACH resources is same as the PRACH configuration index for the legacy resource,
   Additional parameter(s) for determining the additional PRACH resources e.g.
      Scaled/adjusted PRACH configuration period
      Additional timing offset
      Adjusting the parameters (e.g., (x, y) value and slot number) of the PRACH configuration
      Muting/masking ROs
When the PRACH configuration index for the additional PRACH resources is different from the PRACH configuration index for the legacy resource
   Additional mechanisms (if any) for determining the additional PRACH resources e.g.
      Muting/masking ROs (e.g. for the case when the PRACH configuration index for the additional PRACH resources contains legacy resources)
Additional parameters to facilitate condensed/cluster RACH resources in time-domain (including whether needed)

For the adaptation mechanism for additional PRACH resources, study further the following:
Option 1: Higher layer signalling (with potential enhancements) based PRACH resource adaptation
Option 2: L1-based adaptation to indicate whether the additional PRACH resources provided by semi-static signalling are available or not
   FFS: details
   Strive to re-use existing DCI format(s)
Option 3: Adaptation of PRACH transmission according to predefined condition(s)
   FFS: details
Option 4-rev1: L1-based adaptation to indicate whether a subset of the additional PRACH resources provided by semi-static signalling are available or not
   FFS: whether the subset of the additional PRACH resources is in RO level/SSB-to-RO mapping cycle level/PRACH association period level/PRACH association pattern period level for time-domain PRACH adaptation
   Strive to re-use existing DCI format(s)
Option 5: Enhanced cell DRX

### **************************************Quotation End**************************************

The general description of random access (RA) procedure is specified in TS 38.300 ([4] 3GPP TS 38.300 V18.1.0).

### **************************************Quotation Start [4]**********************************

### 9.2.6 Random Access Procedure

The random access procedure is triggered by a number of events:
Initial access from RRC_IDLE;
RRC Connection Re-establishment procedure;
DL or UL data arrival, during RRC_CONNECTED or during RRC_INACTIVE while SDT procedure (see clause 18.0) is ongoing, when UL synchronisation status is “non-synchronised”;
UL data arrival, during RRC_CONNECTED or during RRC_INACTIVE while SDT procedure is ongoing, when there are no PUCCH resources for SR available;
Handover, except for when RACH-less HO is configured;
SR failure;
Explicit request by RRC upon synchronous reconfiguration;
RRC Connection Resume procedure from RRC_INACTIVE;
To establish time alignment for a primary or a secondary TAG;
Request for Other SI (see clause 7.3);
Beam failure recovery;
Consistent UL LBT failure on SpCell;
SDT in RRC_INACTIVE (see clause 18);
Positioning purpose during RRC_CONNECTED requiring random access procedure, e.g., when timing advance is needed for UE positioning;
Early UL synchronization with an LTM candidate cell;
RACH-based LTM cell switch.

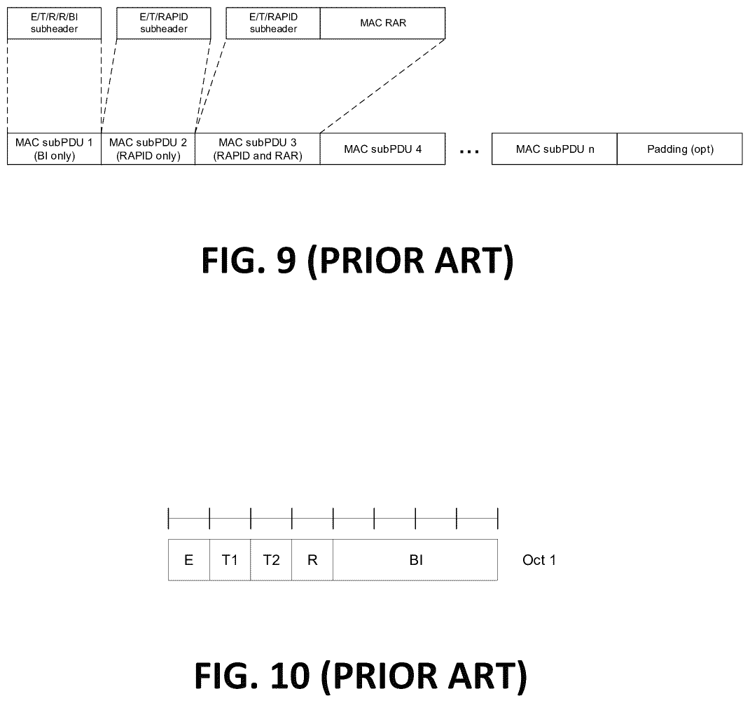

Two types of random access procedure are supported: 4-step RA type with MSG1 and 2-step RA type with MSGA. Both types of RA procedure support contention-based random access (CBRA) and contention-free random access (CFRA) as shown on FIG. 9.2.6-1 below.

The UE selects the type of random access at initiation of the random access procedure based on network configuration
when CFRA resources are not configured, an RSRP threshold is used by the UE to select between 2-step RA type and 4-step RA type;
when CFRA resources for 4-step RA type are configured, UE performs random access with 4-step RA type;
when CFRA resources for 2-step RA type are configured, UE performs random access with 2-step RA type.

The network does not configure CFRA resources for 4-step and 2-step RA types at the same time for a Bandwidth Part (BWP). CFRA with 2-step RA type is only supported for handover.

The MSG1 of the 4-step RA type consists of a preamble on PRACH. After MSG1 transmission, the UE monitors for a response from the network within a configured window. For CFRA, dedicated preamble for MSG1 transmission is assigned by the network and upon receiving random access response from the network, the UE ends the random access procedure as shown in FIG. 9.2.6-1(c). For CBRA, upon reception of the random access response, the UE sends MSG3 using the UL grant scheduled in the response and monitors contention resolution as shown in FIG. 9.2.6-1(a). If contention resolution is not successful after MSG3 (re)transmission(s), the UE goes back to MSG1 transmission.

The MSGA of the 2-step RA type includes a preamble on PRACH and a payload on PUSCH. After MSGA transmission, the UE monitors for a response from the network within a configured window. For CFRA, dedicated preamble and PUSCH resource are configured for MSGA transmission and upon receiving the network response, the UE ends the random access procedure as shown in FIG. 9.2.6-1(d). For CBRA, if contention resolution is successful upon receiving the network response, the UE ends the random access procedure as shown in FIG. 9.2.6-1(b); while if fallback indication is received in MSGB, the UE performs MSG3 transmission using the UL grant scheduled in the fallback indication and monitors contention resolution as shown in FIG. 9.2.6-2. If contention resolution is not successful after MSG3 (re)transmission(s), the UE goes back to MSGA transmission.

If the random access procedure with 2-step RA type is not completed after a number of MSGA transmissions, the UE can be configured to switch to CBRA with 4-step RA type.

For the random access procedure towards an LTM candidate cell for early UL TA acquisition, CFRA triggered by a PDCCH order is used. The UE sends MSG1 towards the cell without monitoring for a response from it as shown in FIG. 9.2.6-1 (e). To support UE power ramping, the UE may perform MSG1 retransmission as indicated by the network.

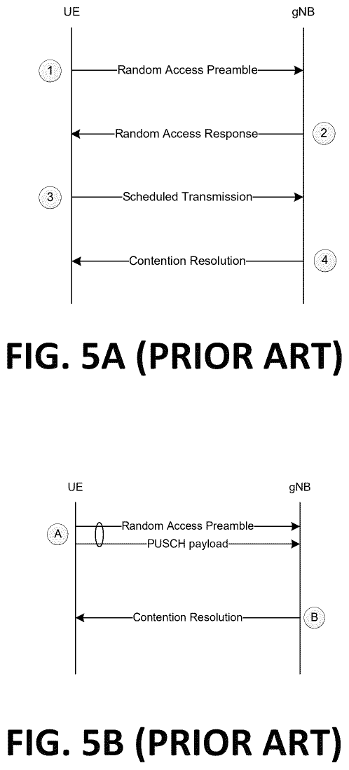

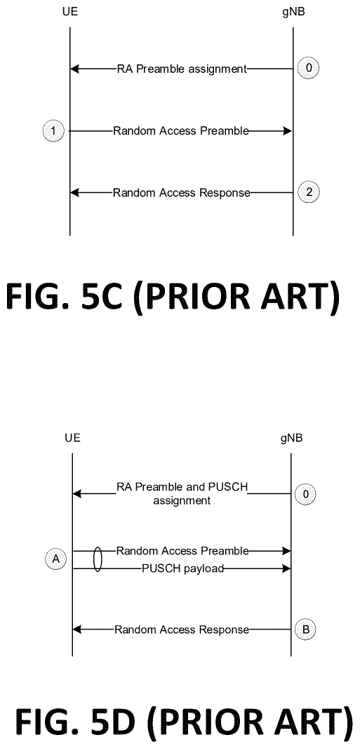

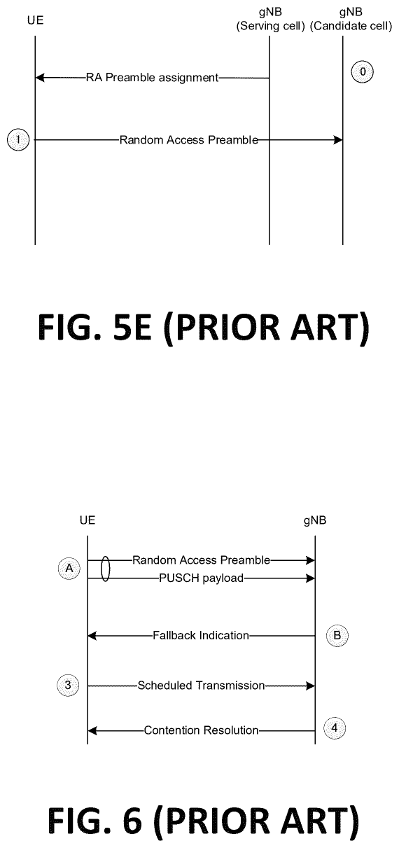

FIG. 5A is a reproduction of FIG. 9.2.6-1: Random Access Procedures—(a) CBRA with 4-step RA type, from 3GPP TS 38.300 V18.1.0.

FIG. 5B is a reproduction of FIG. 9.2.6-1: Random Access Procedures—(b) CBRA with 2-step RA type, from 3GPP TS 38.300 V18.1.0.

FIG. 5C is a reproduction of FIG. 9.2.6-1: Random Access Procedures—(c) CFRA with 4-step RA type, from 3GPP TS 38.300 V18.1.0.

FIG. 5D is a reproduction of FIG. 9.2.6-1: Random Access Procedures—(d) CFRA with 2-step RA type, from 3GPP TS 38.300 V18.1.0.

FIG. 5E is a reproduction of FIG. 9.2.6-1: Random Access Procedures—(e) CFRA without network response with 4-step RA type, from 3GPP TS 38.300 V18.1.0.

FIG. 6 is a reproduction of FIG. 9.2.6-2: Fallback for CBRA with 2-step RA type, from 3GPP TS 38.300 V18.1.0.

For random access in a cell configured with SUL, the network can explicitly signal which carrier to use (UL or SUL). Otherwise, the UE selects the SUL carrier if and only if the measured quality of the DL is lower than a broadcast threshold. UE performs carrier selection before selecting between 2-step and 4-step RA type. The RSRP threshold for selecting between 2-step and 4-step RA type can be configured separately for UL and SUL. Once started, all uplink transmissions of the random access procedure remain on the selected carrier.

. . .

When CA is configured, random access procedure with 2-step RA type is only performed on PCell while contention resolution can be cross-scheduled by the PCell.

When CA is configured, for random access procedure with 4-step RA type, the first three steps of CBRA always occur on the PCell while contention resolution (step 4) can be cross-scheduled by the PCell. The three steps of a CFRA started on the PCell remain on the PCell. CFRA on SCell can only be initiated by the gNB to establish timing advance for a secondary TAG: the procedure is initiated by the gNB with a PDCCH order (step 0) that is sent on an activated SCell of the secondary TAG, preamble transmission (step 1) takes place on the SCell, and Random Access Response (step 2) takes place on PCell.

When two TAG IDs are configured for the serving cell, the TAG for which the TA command is applied is indicated in Random Access Response message or in MSGB.

### **************************************Quotation End**************************************

In addition, the current RA procedure is specified in TS 38.321 ([5] 3GPP TS 38.321 V18.1.0).

### **************************************Quotation Start [51]**************************************

### 5.1 Random Access Procedure

### 5.1.1 Random Access Procedure Initialization

. . .

When a Random Access procedure is initiated, UE selects a set of Random Access resources as specified in clause 5.1.1b and initialises the following parameters for the Random Access procedure according to the values configured by RRC for the selected set of Random Access resources:
prach-ConfigurationIndex: the available set of PRACH occasions for the transmission of the Random Access Preamble for Msg1. These are also applicable to the MSGA PRACH if the PRACH occasions are shared between 2-step and 4-step RA types;
. . .
rsrp-ThresholdMsg1-RepetitionNum2: an RSRP threshold for Msg1 repetition with repetition number 2 (see clause 5.1.1b);
rsrp-ThresholdMsg1-RepetitionNum4: an RSRP threshold for Msg1 repetition with repetition number 4 (see clause 5.1.1b);
rsrp-ThresholdMsg1-RepetitionNum8: an RSRP threshold for Msg1 repetition with repetition number 8 (see clause 5.1.1b);
. . .
scalingFactorBI: a scaling factor for prioritized Random Access procedure;
ra-PreambleIndex: Random Access Preamble;
. . .
ra-OccasionList: defines PRACH occasion(s) associated with a CSI-RS in which the MAC entity may transmit a Random Access Preamble;
ra-PreambleStartIndex: the starting index of Random Access Preamble(s) for on-demand SI request;
. . .
preambleTransMax: the maximum number of Random Access Preamble transmission;
preambleTransMax-Msg1-Repetition: the maximum number of Random Access Preamble transmissions with a given Msg1 repetition number before switching to Msg1 repetition with the next available higher Msg1 repetition number,
. . .
the set of Random Access Preambles and/or PRACH occasions for SI request, if any;
. . .

When the Random Access procedure is initiated on a Serving Cell or for an LTM candidate cell, the MAC entity shall:

. . .
1> set the PREAMBLE_BACKOFF to 0 ms;
. . .
1> select the set of Random Access resources applicable to the current Random Access procedure according to clause 5.1.1b;
1> if the Random Access procedure is initiated by PDCCH order and if the ra-PreambleIndex explicitly provided by PDCCH is not 0b000000; or
1> if the Random Access procedure was initiated for SI request (as specified in TS 38.331) and the Random Access Resources for SI request have been explicitly provided by RRC; or
. . .
1> if the Random Access procedure was initiated for LTM cell switch and if the contention-free Random Access Resources have been explicitly provided in LTM Cell Switch Command MAC CE:
   2> set the RA_TYPE to 4-stepRA.
   . . .
1> else:
   2> set the RA_TYPE to 4-stepRA.
. . .
1> if RA_TYPE is set to 2-stepRA:
   2> perform the Random Access Resource selection procedure for 2-step RA type (see clause 5.1.2a).
1> else:
   2> perform the Random Access Resource selection procedure (see clause 5.1.2).

### 5.1.1a Initialization of Variables Specific to Random Access Type

The MAC entity shall:
1> if RA_TYPE is set to 2-stepRA:
   . . .
   2> set SCALING_FACTOR_BI to 1;
   . . .
   2> if the Random Access procedure was initiated for SpCell beam failure recovery (as specified in clause 5.17); and
   2> if beamFailureRecoveryConfig is configured for the active UL BWP of the selected carrier, and
   2> if ra-PrioritizationTwoStep is configured in the beamFailureRecoveryConfig:
      3> set PREAMBLE_POWER_RAMPING_STEP to the powerRampingStepHighPriority included in the ra-PrioritizationTwoStep in beamFailureRecoveryConfig;
      3> if scalingFactorBI is configured in the ra-PrioritizationTwoStep in beamFailureRecoveryConfig:
         4> set SCALING_FACTOR_BI to the scalingFactorBI.
   2> else if the Random Access procedure was initiated for reconfiguration with sync or for SCG activation; and
   2> if rach-ConfigDedicated is configured for the selected carrier, and
   2> if ra-PrioritizationTwoStep is configured in the rach-ConfigDedicated:
      3> set PREAMBLE_POWER_RAMPING_STEP to the powerRampingStepHighPriority included in the ra-PrioritizationTwoStep in rach-ConfigDedicated;
      3> if scalingFactorBI is configured in ra-PrioritizationTwoStep in the rach-ConfigDedicated:
         4> set SCALING_FACTOR_BI to the scalingFactorBI.
   . . .
1> else (i.e. RA_TYPE is set to 4-stepRA):
   2> set SCALING_FACTOR_BI to 1;
   2> set preambleTransMax to preambleTransMax included in the RACH-ConfigGeneric;
   . . .
   2> if the Random Access procedure was initiated for beam failure recovery (as specified in clause 5.17); and
   2> if beamFailureRecoveryConfig is configured for the active UL BWP of the selected carrier, and
   2> if ra-Prioritization is configured in the beamFailureRecoveryConfig:
      3> set PREAMBLE_POWER_RAMPING_STEP to the powerRampingStepHighPriority included in the ra-Prioritization in beamFailureRecoveryConfig;
      3> if scalingFactorBI is configured in ra-Prioritization in the beamFailureRecoveryConfig;
         4> set SCALING_FACTOR_BI to the scalingFactorBI.
   2> else if the Random Access procedure was initiated for reconfiguration with sync or for SCG activation; and
   2> if rach-ConfigDedicated is configured for the selected carrier, and
   2> if ra-Prioritization is configured in the rach-ConfigDedicated:
      3> set PREAMBLE_POWER_RAMPING_STEP to the powerRampingStepHighPriority included in the ra-Prioritization in rach-ConfigDedicated;
      3> if scalingFactorBI is configured in ra-Prioritization in the rach-ConfigDedicated:
         4> set SCALING_FACTOR_BI to the scalingFactorBI.
   . . .

### 5.1.1b Selection of the Set of Random Access Resources for the Random Access Procedure

The MAC entity shall:
. . .
1> if neither contention-free Random Access Resources nor Random Access Resources for SI request have been provided for this Random Access procedure and one or more of the features including (e)RedCap and/or Slicing and/or SDT and/or MSG3 repetition and/or MSG1 repetition is applicable for this Random Access procedure:
   . . .
1> else:
   . . .
   2> else if the Random Access procedure was initiated for SI request and Random Access Resources associated with Msg1 repetition for SI request and Msg1 repetition number have been provided for this Random Access procedure:
      3> select the set of Random Access resources that is only configured with Msg1 repetition indication and associated with the indicated Msg1 repetition number for this Random Access procedure.
   2> else:
      3> select the set of Random Access resources that are not associated with any feature indication (as specified in clause 5.1.1c) for the current Random Access procedure.

### 5.1.1c Availability of the Set of Random Access Resources

The MAC entity shall for each set of configured Random Access resources for 4-step RA type and for each set of configured Random Access resources for 2-step RA type:
. . .
1> if msg1-Repetitions is set to true for a set of Random Access resources:
   2> if Msg1 repetition is not applicable to the current Random Access procedure; or
   2> if the set of Random Access resources is not associated with any of the Msg1 repetition number that is applicable to the current Random Access procedure:
      3> consider the set of Random Access resources as not available for the Random Access procedure.
1> if a set of Random Access resources is not configured with FeatureCombination:
   2> consider the set of Random Access resources to not associated with any feature.
      5.1.2 Random Access Resource selection

If the selected RA TYPE is set to 4-stepRA, the MAC entity shall:
1> else if the Random Access procedure was initiated for SI request (as specified in TS 38.331); and
1> if the Random Access Resources for SI request have been explicitly provided by RRC:
   2> if at least one of the SSBs with SS-RSRP above rsrp-ThresholdSSB is available:
      3> select an SSB with SS-RSRP above rsrp-ThresholdSSB.
   2> else:
      3> select any SSB.
   2> select a Random Access Preamble corresponding to the selected SSB, from the Random Access Preamble(s) determined according to ra-PreambleStartIndex as specified in TS 38.331;
   2> set the PREAMBLE_INDEX to selected Random Access Preamble.
   . . .
1> if the Random Access procedure was initiated for SI request (as specified in TS 38.331); and
1> if ra-AssociationPeriodIndex and si-RequestPeriod are configured:
   2> determine the next available PRACH occasion from the PRACH occasions corresponding to the selected SSB in the association period given by ra-AssociationPeriodIndex in the si-RequestPeriod permitted by the restrictions given by the ra-ssb-OccasionMaskIndex if configured (the MAC entity shall select a PRACH occasion randomly with equal probability amongst the consecutive PRACH occasions according to clause 8.1 of TS 38.213 corresponding to the selected SSB).
1> else if an SSB is selected above:
   2> if the set of Random Access resources associated with Msg1 repetition is selected for this Random Access procedure:
      3> determine the next available set of PRACH occasions (as specified in TS 38.213) for the Msg1 repetition number applicable for this Random Access procedure corresponding to the selected SSB, permitted by the restrictions given by the ra-ssb-OccasionMaskIndex if configured, or ssb-SharedRO-MaskIndex if configured (the MAC entity shall select a set of PRACH occasions randomly with equal probability amongst sets of PRACH occasions according to clause 8.1 of TS 38.213 regardless the FR2 UL gap, corresponding to the selected SSB and selected Msg1 repetition number for this Random Access procedure; the MAC entity may take into account the possible occurrence of measurement gaps and MUSIM gaps when determining the next available set of PRACH occasions corresponding to the selected SSB).
   2> else:
      3> determine the next available PRACH occasion from the PRACH occasions corresponding to the selected SSB permitted by the restrictions given by the ra-ssb-OccasionMaskIndex if configured, or ssb-SharedRO-MaskIndex if configured, or indicated by PDCCH, or indicated by the LTM Cell Switch Command MAC CE (the MAC entity shall select a PRACH occasion randomly with equal probability amongst the consecutive PRACH occasions according to clause 8.1 of TS 38.213 regardless the FR2 UL gap, corresponding to the selected SSB; the MAC entity may take into account the possible occurrence of measurement gaps and MUSIM gaps when determining the next available PRACH occasion corresponding to the selected SSB).
1> else if a CSI-RS is selected above:
   2> if there is no contention-free Random Access Resource associated with the selected CSI-RS:
      3> determine the next available PRACH occasion from the PRACH occasions, permitted by the restrictions given by the ra-ssb-OccasionMaskIndex if configured, corresponding to the SSB in candidateBeamRSList which is quasi-colocated with the selected CSI-RS as specified in TS 38.214 (the MAC entity shall select a PRACH occasion randomly with equal probability amongst the consecutive PRACH occasions according to clause 8.1 of TS 38.213 regardless the FR2 UL gap, corresponding to the SSB which is quasi-colocated with the selected CSI-RS; the MAC entity may take into account the possible occurrence of measurement gaps and MUSIM gaps when determining the next available PRACH occasion corresponding to the SSB which is quasi-colocated with the selected CSI-RS).
   2> else:
      3> determine the next available PRACH occasion from the PRACH occasions in ra-OccasionList corresponding to the selected CSI-RS (the MAC entity shall select a PRACH occasion randomly with equal probability amongst the PRACH occasions occurring simultaneously but on different subcarriers regardless the FR2 UL gap, corresponding to the selected CSI-RS; the MAC entity may take into account the possible occurrence of measurement gaps and MUSIM gaps when determining the next available PRACH occasion corresponding to the selected CSI-RS).
1> perform the Random Access Preamble transmission procedure (see clause 5.1.3).
. . .

### 5.1.2a Random Access Resource Selection for 2-Step RA Type

If the selected RA TYPE is set to 2-stepRA, the MAC entity shall:
. . .
1> determine the next available PRACH occasion from the PRACH occasions corresponding to the selected SSB permitted by the restrictions given by the msgA-SSB-SharedRO-MaskIndex if configured, or ra-ssb-OccasionMaskIndex if configured, or ssb-SharedRO-MaskIndex if configured (the MAC entity shall select a PRACH occasion randomly with equal probability among the consecutive PRACH occasions allocated for 2-step RA type according to clause 8.1 of TS 38.213 regardless the FR2 UL gap, corresponding to the selected SSB; the MAC entity may take into account the possible occurrence of measurement gaps and MUSIM gaps when determining the next available PRACH occasion corresponding to the selected SSB);
   . . .
1> perform the MSGA transmission procedure (see clause 5.1.3a).

### 5.1.3 Random Access Preamble Transmission

The MAC entity shall, for each Random Access Preamble:
. . .
1> if LBT failure indication is received from lower layers for this Random Access Preamble transmission:
   2> if lbt-FailureRecoveryConfig is configured:
   . . .
   2> else:
      3> if PREAMBLE_TRANSMISSION_COUNTER=preambleTransMax+1:
         4> if the Random Access Preamble is transmitted on the SpCell:
         . . .
         5> if this Random Access procedure was triggered for SI request:
         6> consider the Random Access procedure unsuccessfully completed.
         . . .

The RA-RNTI associated with the PRACH occasion in which the Random Access Preamble is transmitted or the RA-RNTI associated with the last valid PRACH occasion in the set of PRACH occasions (as specified in TS 38.213) for Msg1 repetition, is computed as:

$$RA - RNTI = 1 + s\_id + 14 \times t\_id + 14 \times 80 \times f\_id + 14 \times 80 \times 8 \times ul\_carrier \_id$$

where s_id is the index of the first OFDM symbol of the PRACH occasion (0≤s_id<14), t_id is the index of the first slot of the PRACH occasion in a system frame (0≤t_id<80), where the subcarrier spacing to determine t_id is based on the value of μ specified in clause 5.3.2 in TS 38.211 for μ=10, 1, 2, 3), and for μ={5, 6}, t_id is the index of the 120 kHz slot in a system frame that contains the PRACH occasion (0≤t_id<80), f_id is the index of the PRACH occasion in the frequency domain (0≤f_id<8), and ul_carrier_id is the UL carrier used for Random Access Preamble transmission (0 for NUL carrier, and 1 for SUL carrier).

### 5.1.3a MSGA Transmission

The MAC entity shall, for each MSGA:

```
...
1> if LBT failure indication is received from lower layers for the
transmission of this MSGA Random Access
  Preamble:
  ...
  2> if lbt-FailureRecoveryConfig is configured:
    ...
  2> else:
    ...
    3> if PREAMBLE_TRANSMISSION_COUNTER =
    preambleTransMax + 1:
      ...
      4> if this Random Access procedure was triggered
      for SI request:
        5> consider this Random Access procedure
        unsuccessfully completed.
...
```

The MSGB-RNTI associated with the PRACH occasion in which the Random Access Preamble is transmitted, is computed as:

$$MSGB - RNTI = 1 + s\_id + 14 \times t\_id + 14 \times 80 \times f\_id + 14 \times 80 \times 8 \times ul\_carrier \_id + 14 \times 80 \times 8 \times 2$$

where s_id is the index of the first OFDM symbol of the PRACH occasion (0≤s_id<14), t_id is the index of the first slot of the PRACH occasion in a system frame (0<t_id<0), where the subcarrier spacing to determine t_id is based on the value of μ specified in clause 5.3.2 in TS 38.211 for μ={0, 1, 2, 3}, and for μ={5, 6}, t_id is the index of the 120 kHz slot in a system frame that contains the PRACH occasion (0<t_id<80), f_id is the index of the PRACH occasion in the frequency domain (0≤f_id<8), and ul_carrier_id is the UL carrier used for Random Access Preamble transmission (0 for NUL carrier, and 1 for SUL carrier). The RA-RNTI is calculated as specified in clause 5.1.3.

### 5.1.4 Random Access Response Reception

Once the Random Access Preamble is transmitted and regardless of the possible occurrence of a measurement gap, the MAC entity shall:
1> if the contention-free Random Access Preamble for beam failure recovery request was transmitted by the MAC entity:
   . . .
1> else:
   . . .
   2> else if the Random Access Preamble is transmitted with repetitions:
      3> start the ra-ResponseWindow configured in RACH-ConfigCommon at the first PDCCH occasion from the end of all repetitions of the Random Access Preamble transmission as specified in TS 38.213.
   2> else:
      3> start the ra-ResponseWindow configured in RACH-ConfigCommon at the first PDCCH occasion as specified in TS 38.213 from the end of the Random Access Preamble transmission.
   2> monitor the PDCCH of the SpCell for Random Access Response(s) identified by the RA-RNTI while the ra-ResponseWindow is running.
1> if notification of a reception of a PDCCH transmission on the search space indicated by recoverySearchSpaceId is received from lower layers on the Serving Cell where the preamble was transmitted; and
1> if PDCCH transmission is addressed to the C-RNTI; and
1> if the contention-free Random Access Preamble for beam failure recovery request was transmitted by the MAC entity:
   2> consider the Random Access procedure successfully completed.
1> else if a valid (as specified in TS 38.213) downlink assignment has been received on the PDCCH for the RA-RNTI and the received TB is successfully decoded:
   2> if the Random Access Response contains a MAC subPDU with Backoff Indicator:
      3> set the PREAMBLE BACKOFF to value of the BI field of the MAC subPDU using Table 7.2-1, multiplied with SCALING_FACTOR_BI.
   2> else:
      3> set the PREAMBLE_BACKOFF to 0 ms.
   2> if the Random Access Response contains a MAC subPDU with Random Access Preamble identifier corresponding to the transmitted PREAMBLE_INDEX (see clause 5.1.3):
      3> consider this Random Access Response reception successful.
   2> if the Random Access Response reception is considered successful:
      3> if the Random Access Response includes a MAC subPDU with RAPID only:
         4> consider this Random Access procedure successfully completed;
         4> indicate the reception of an acknowledgement for SI request to upper layers.
      . . .

### 5.1.4a MSGB Reception and Contention Resolution for 2-Step RA Type

Once the MSGA preamble is transmitted, regardless of the possible occurrence of a measurement gap, the MAC entity shall:
1> start the msgB-Response Window at the PDCCH occasion as specified in TS 38.213, clause 8.2A;
1> monitor the PDCCH of the SpCell for a Random Access Response identified by MSGB-RNTI while the msgB-ResponseWindow is running;
   . . .
1> if notification of a reception of a PDCCH transmission of the SpCell is received from lower layers:
   . . .
   2> if a valid (as specified in TS 38.213) downlink assignment has been received on the PDCCH for the MSGB-RNTI and the received TB is successfully decoded:
      3> if the MSGB contains a MAC subPDU with Backoff Indicator:
         4> set the PREAMBLE_BACKOFF to value of the BI field of the MAC subPDU using Table 7.2-1, multiplied with SCALING_FACTOR_BI.
      3> else:
         4> set the PREAMBLE_BACKOFF to 0 ms.
      3> if the MSGB contains a fallbackRAR MAC subPDU; and
      3> if the Random Access Preamble identifier in the MAC subPDU matches the transmitted PREAMBLE_INDEX (see clause 5.1.3a):
         . . .
      3> else if the MSGB contains a successRAR MAC subPDU; and
      3> if the CCCH SDU was included in the MSGA and the UE Contention Resolution Identity in the MAC subPDU matches the CCCH SDU:
         . . .
         4> if this Random Access procedure was initiated for SI request:
         5> indicate the reception of an acknowledgement for SI request to upper layers.
         . . .
         4> consider this Random Access Response reception successful;
         4> consider this Random Access procedure successfully completed;
         . . .

### 5.1.5 Contention Resolution

Once Msg3 is transmitted the MAC entity shall:
1> if the Msg3 transmission (i.e. initial transmission or HARQ retransmission) is scheduled with PUSCH repetition Type A:
   . . .
   2> else:
      3> start or restart the ra-ContentionResolutionTimer in the first symbol after the end of all repetitions of the Msg3 transmission.
   . . .
1> else:
   2> start or restart the ra-ContentionResolutionTimer in the first symbol after the end of the Msg3 transmission.
1> monitor the PDCCH while the ra-ContentionResolutionTimer is running regardless of the possible occurrence of a measurement gap;
1> if notification of a reception of a PDCCH transmission of the SpCell is received from lower layers:
   2> if the C-RNTI MAC CE was included in Msg3:
      3> if the Random Access procedure was initiated for SpCell beam failure recovery or for beam failure recovery of both BFD-RS sets of SpCell (as specified in clause 5.17) and the PDCCH transmission is addressed to the C-RNTI; or
      3> if the Random Access procedure was initiated by a PDCCH order and the PDCCH transmission is addressed to the C-RNTI; or
      3> if the Random Access procedure was initiated for SDT beam failure recovery (as specified in clause 5.27.1) and the PDCCH transmission is addressed to the C-RNTI; or
      3> if the Random Access procedure was initiated by the MAC sublayer itself or by the RRC sublayer and the PDCCH transmission is addressed to the C-RNTI and contains a UL grant for a new transmission:
         . . .
         4> consider this Random Access procedure successfully completed.
   2> else if the CCCH SDU was included in Msg3 and the PDCCH transmission is addressed to its TEMPORARY_C-RNTI:
      3> if the MAC PDU is successfully decoded:
         . . .
         4> if the MAC PDU contains a UE Contention Resolution Identity MAC CE; and
         4> if the UE Contention Resolution Identity in the MAC CE matches the CCCH SDU transmitted in Msg3:
         . . .
         5> if this Random Access procedure was initiated for SI request:
         6> indicate the reception of an acknowledgement for SI request to upper layers.
         . . .
         5> consider this Random Access procedure successfully completed.
         4> else:
         5> discard the TEMPORARY_C-RNTI;
         5> consider this Contention Resolution not successful and discard the successfully decoded MAC PDU.
      3> else, for eRedCap UE, if lower layer detects that PDSCH transmission scheduled by PDCCH has a larger bandwidth than UE can receive or process per slot:
         4> stop ra-ContentionResolutionTimer,
         4> discard the TEMPORARY_C-RNTI;
         4> consider this Contention Resolution not successful.

### **************************************Quotation End**************************************

Some configurations related to BWP, system information, and RA in current standard are specified in TS 38.331 ([6] 3GPP TS 38.331 V18.1.0):

### **************************************Quotation Start [6]**********************************

### BWP-UplinkCommon

The IE BWP-UplinkCommon is used to configure the common parameters of an uplink BWP. They are “cell specific” and the network ensures the necessary alignment with corresponding parameters of other UEs. The common parameters of the initial bandwidth part of the PCell, excluding additionalRACH-perPCI-ToAddModList and additionalRACH-perPCI-ToReleaseList, are also provided via system information. For all other serving cells, the network provides the common parameters via dedicated signalling.

### BWP-UplinkCommon Information Element

| | |
|---|---|
| BWP-UplinkCommon ::= | SEQUENCE { |

...

| | |
|---|---|
| rach-ConfigCommon | SetupRelease { RACH-ConfigCommon } |

```
OPTIONAL, -- Need M
  ...,
  [[
  ...
```

| | |
|---|---|
| msgA-ConfigCommon-r16 | SetupRelease { MsgA-ConfigCommon-r16 } |

```
OPTIONAL -- Cond SpCellOnly2
  ]],
  [[
  enableRA-PrioritizationForSlicing-r17 BOOLEAN
OPTIONAL, -- Cond RA-PrioSliceAI
```

| | |
|---|---|
| additionalRACH-ConfigList-r17 | SetupRelease { AdditionalRACH-ConfigList-r17 } |

```
OPTIONAL, -- Cond SpCellOnly2
  ...
  ]],
  [[
```

| | |
|---|---|
| additionalRACH-perPCI-ToAddModList-r18 | SEQUENCE (SIZE (1.. maxNrofAdditional PRACHConfigs-r18)) |

OF RACH-ConfigTwoTA-r18
OPTIONAL, -- Cond 2TA-Only

| | |
|---|---|
| additionalRACH-perPCI-ToReleaseList-r18 | SEQUENCE (SIZE (1.. maxNrofAdditionalPRACHConfigs-r18)) |

OF RACH-ConfigTwoTAIndex-r18
OPTIONAL, -- Need N

| | |
|---|---|
| rsrp-ThresholdMsg1-RepetitionNum2-r18 | RSRP-Range |

OPTIONAL, -- Need R

| | |
|---|---|
| rsrp-ThresholdMsg1-RepetitionNum4-r18 | RSRP-Range |

OPTIONAL, -- Need R

| | |
|---|---|
| rsrp-ThresholdMsg1-RepetitionNum8-r18 | RSRP-Range |

OPTIONAL, -- Need R

| | |
|---|---|
| preambleTransMax-Msg1-Repetition-r18 | ENUMERATED {n1, n2, n4, n6, n8, n10, n20, n50, n100, |

n200} OPTIONAL -- Cond Msg1Rep1
]]
}

| | |
|---|---|
| AdditionalRACH-ConfigList-r17 ::= | SEQUENCE (SIZE(1..maxAdditionalRACH-r17)) OF AdditionalRACH- |

Config-r17

| | |
|---|---|
| AdditionalRACH-Config-r17 ::= | SEQUENCE { |
| rach-ConfigCommon-r17 | RACH-ConfigCommon |

OPTIONAL, -- Need R

| | |
|---|---|
| msgA-ConfigCommon-r17 | MsgA-ConfigCommon-r16 |

OPTIONAL, -- Need R
...
}

| | |
|---|---|
| NumberOfMsg3-Repetitions-r17::= | ENUMERATED {n1, n2, n3, n4, n7, n8, n12, n16} |

BWP-UplinkCommon field descriptions

msgA-ConfigCommon
Configuration of the cell specific PRACH and PUSCH resource parameters for transmission of MsgA in 2-step random
access type procedure. The NW can configure msgA-ConfigCommon only for UL BWPs if the linked DL BWPs (same
bwp-Id as UL-BWP) are the initial DL BWPs or DL BWPs containing the SSB associated to the initial DL BWP or DL
BWPs associated with nonCellDefiningSSB or, for (e)RedCap UEs, the RedCap-specific initial downlink BWP.
preambleTransMax-Msg1-Repetition
Max number of transmissions of MSG1 repetitions number (2, 4 and 8) performed before switching to higher repetition
number (see TS 38.321, clauses 5.1.1). This field is only applicable when more than one repetition numbers are
configured in shared RO. If the field is absent, switching from lower repetition number to higher repetition number is not
allowed.
rach-ConfigCommon
Configuration of cell specific random access parameters which the UE uses for contention based and contention free
random access as well as for contention based beam failure recovery in this BWP. The NW configures SSB-based RA
(and hence RACH-ConfigCommon) only for UL BWPs if the linked DL BWPs (same bwp-Id as UL-BWP) are the initial
DL BWPs or DL BWPs containing the SSB associated to the initial DL BWP or DL BWPs associated with
nonCellDefiningSSB or, for (e)RedCap UEs, the RedCap-specific initial downlink BWP. The network configures rach-
ConfigCommon (without suffix) and/or rach-ConfigCommon-r17, whenever it configures contention free random access
(for reconfiguration with sync or for beam failure recovery), the UE then applies the corresponding configuration
depending on the RACH resource set selected upon RACH initialization, as specified in TS 38.321. For RedCap-
specific initial uplink BWP, rach-ConfigCommon is always configured when msgA-ConfigCommon is configured in this
BWP.
rsrp-ThresholdMsg1-RepetitionNum2, rsrp-ThresholdMsg1-RepetitionNum4, rsrp-ThresholdMsg1-
RepetitionNum8
Threshold used by the UE for determining whether to select resources indicating Msg1 repetition number 2, 4 or 8 in
this BWP, as specified in TS 38.321. The value applies to all the BWPs and all RACH configurations. For a given MSG1
repetition number, this corresponding field is mandatory if both set(s) of Random Access resources with MSG1
repetition indication associated with this MSG1 repetition number and set(s) of Random Access resources without
MSG1 repetition indication are configured in the BWP, or if the set(s) of Random Access resources with MSG1
repetition indication associated with this MSG1 repetition number and set(s) of Random Access resources with MSG1
repetition indication associated with a lower repetition number are configured in the BWP. It is absent otherwise.

### **************************************Next Quotation**************************************

### SI-RequestConfig

The IE SI-RequestConfig contains configuration for Msg1 based SI request without Msg1 repetition.

### SI-RequestConfig Information Element

| | |
|---|---|
| SI-RequestConfig ::= | SEQUENCE { |
| rach-OccasionsSI | SEQUENCE { |
| rach-ConfigSI | RACH-ConfigGeneric, |
| ssb-perRACH-Occasion | ENUMERATED {oneEighth, oneFourth, oneHalf, one, two, |

four, eight, sixteen}
}
OPTIONAL, -- Need R

| | |
|---|---|
| si-Request Period | ENUMERATED {one, two, four, six, eight, ten, twelve, sixteen} |

OPTIONAL, -- Need R

| | |
|---|---|
| si-RequestResources | SEQUENCE (SIZE (1..maxSI-Message)) OF SI-RequestResources |

}

| | |
|---|---|
| SI-RequestResources ::= | SEQUENCE { |
| ra-PreambleStartIndex | INTEGER (0..63), |
| ra-AssociationPeriodIndex | INTEGER (0..15) |

OPTIONAL, -- Need R

| | |
|---|---|
| ra-ssb-OccasionMaskIndex | INTEGER (0..15) |

OPTIONAL -- Need R
}

SI-RequestConfig field descriptions

rach-OccasionsSI
Configuration of dedicated RACH Occasions for SI. If the field is absent, the UE uses the corresponding parameters
configured in rach-ConfigCommon of the initial uplink BWP.
si-RequestPeriod
Periodicity of the SI-Request configuration in number of association periods.

### **************************************Next Quotation**************************************

### RACH-ConfigCommon

The IE RACH-ConfigCommon is used to specify the cell specific random-access parameters.

### RACH-ConfigCommon Information Element

| | |
|---|---|
| RACH-ConfigCommon ::= | SEQUENCE { |
| rach-ConfigGeneric | RACH-ConfigGeneric, |
| totalNumberOfRA-Preambles | INTEGER (1..63) |

OPTIONAL, -- Need S

| | |
|---|---|
| ssb-perRACH-OccasionAndCB-PreamblesPerSSB | CHOICE { |
| oneEighth | ENUMERATED |

{n4,n8,n12,n16,n20,n24,n28,n32,n36,n40,n44,n48,n52,n56,n60,n64},

| | |
|---|---|
| one Fourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |

}
OPTIONAL, -- Need M

| | |
|---|---|
| groupBconfigured | SEQUENCE { |

...

| | |
|---|---|
| numberOfRA-PreamblesGroupA | INTEGER (1..64) |

```
  }
OPTIONAL, -- Need R
  ...
```

| | |
|---|---|
| msg1-SubcarrierSpacing | SubcarrierSpacing |

```
OPTIONAL, -- Cond L139
  ...,
  [[
```

| | |
|---|---|
| ra-PrioritizationForAccessIdentity-r16 | SEQUENCE { |
| ra-Prioritization-r16 | RA-Prioritization, |
| ra-PrioritizationForAI-r16 | BIT STRING (SIZE (2)) |

```
  }
OPTIONAL, -- Cond InitialBWP-Only
  ...
  ]]
}
```

RACH-ConfigCommon field descriptions

numberOfRA-PreamblesGroupA
The number of CB preambles per SSB in group A. This determines implicitly the number of CB preambles per SSB
available in group B. (see TS 38.321, clause 5.1.1). The setting should be consistent with the setting of ssb-perRACH-
OccasionAndCB-PreamblesPerSSB.
ra-Prioritization
Parameters which apply for prioritized random access procedure on any UL BWP of SpCell for specific Access
Identities (see TS 38.321, clause 5.1.1a).
ra-PrioritizationForSlicing
Parameters which apply to configure prioritized CBRA 4-step random access type for slicing.
rach-ConfigGeneric
RACH parameters for both regular random access and beam failure recovery.
ssb-perRACH-OccasionAndCB-PreamblesPerSSB
The meaning of this field is twofold: the CHOICE conveys the information about the number of SSBs per RACH
occasion. Value oneEighth corresponds to one SSB associated with 8 RACH occasions, value oneFourth
corresponds to one SSB associated with 4 RACH occasions, and so on. The ENUMERATED part indicates the
number of Contention Based preambles per SSB. Value n4 corresponds to 4 Contention Based preambles per
SSB, value n8 corresponds to 8 Contention Based preambles per SSB, and so on. The total number of CB
preambles in a RACH occasion is given by CB-preambles-per-SSB * max(1, SSB-per-rach-occasion). See TS
38.213.
totalNumberOfRA-Preambles
Total number of preambles used for contention based and contention free 4-step or 2-step random access in
the RACH resources defined in RACH-ConfigCommon, excluding preambles used for other purposes (e.g. for
SI request). If the field is absent, all 64 preambles are available for RA. The setting should be consistent with
the setting of ssb-perRACH-OccasionAndCB-PreamblesPerSSB, i.e. it should be a multiple of the number of
SSBs per RACH occasion.

### RACH-ConfigCommonTwoStepRA

The IE RACH-ConfigCommonTwoStepRA is used to specify cell specific 2-step random-access type parameters.

### RACH-ConfigCommonTwoStepRA Information Element

| | |
|---|---|
| RACH-ConfigCommonTwoStepRA-r16 ::= | SEQUENCE { |
| rach-ConfigGenericTwoStepRA-r16 | RACH-ConfigGenericTwoStepRA-r16, |
| msgA-TotalNumberOfRA-Preambles-r16 | INTEGER (1..63) |

OPTIONAL, -- Need S

| | |
|---|---|
| msgA-SSB-PerRACH-OccasionAndCB-PreamblesPerSSB-r16 | CHOICE { |
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED |

{n4,n8,n12,n16,n20,n24,n28,n32},

| | |
|---|---|
| four | INTEGER (1..16), |
| eight | INTEGER (1..8), |
| sixteen | INTEGER (1..4) |

```
  }
OPTIONAL, -- Cond 2StepOnly
  ...
```

| | |
|---|---|
| ra-PrioritizationForAccessIdentityTwoStep-r16 | SEQUENCE { |
| ra-Prioritization-r16 | RA-Prioritization, |
| ra-PrioritizationForAI-r16 | BIT STRING (SIZE (2)) |

```
  }
OPTIONAL, -- Cond InitialBWP-Only
  ...,
}
```

| | |
|---|---|
| GroupB-ConfiguredTwoStepRA-r16 ::= | SEQUENCE { |
| ra-MsgA-SizeGroupA-r16 | ENUMERATED {b56, b144, b208, b256, b282, |

b480, b640, b800,

b1000, b72, spare6, spare5,

spare4, spare3, spare2, spare1},
...

| | |
|---|---|
| numberOfRA-PreamblesGroupA-r16 | INTEGER (1..64) |

}

RACH-ConfigCommonTwoStepRA field descriptions

msgA-CB-PreamblesPerSSB-PerSharedRO
Number of contention-based preambles used for 2-step RA type from the non-CBRA 4-step type preambles associated
with each SSB for RO shared with 4-step type RA. The number of preambles for 2-step RA type shall not exceed the
number of preambles per SSB minus the number of contention-based preambles per SSB for 4-step type RA. The
possible value range for this parameter needs to be aligned with value range for the configured SSBs per RACH
occasion in ssb-perRACH-OccasionAndCB-PreamblesPerSSB in RACH-ConfigCommon. The field is only applicable for
the case of shared ROs with 4-step type random access.
msgA-SSB-PerRACH-OccasionAndCB-PreamblesPerSSB
The meaning of this field is twofold: the CHOICE conveys the information about the number of SSBs per RACH
occasion. Value oneEight corresponds to one SSB associated with 8 RACH occasions, value oneFourth
corresponds to one SSB associated with 4 RACH occasions, and so on. The ENUMERATED part indicates the
number of Contention Based preambles per SSB. Value n4 corresponds to 4 Contention Based preambles per
SSB, value n8 corresponds to 8 Contention Based preambles per SSB, and so on. The total number of CB
preambles in a RACH occasion is given by CB-preambles-per-SSB * max(1, SSB-per-rach-occasion). If the field
is not configured in RACH-ConfigCommonTwoStepRA which is configured directly within a BWP (i.e. not within
AdditionalRACH-Config) and both 2-step and 4-step are configured for the BWP, the UE applies the value in the
field ssb-perRACH-OccasionAndCB-PreamblesPerSSB in RACH-ConfigCommon. If the field is not configured
in AdditionalRACH-Config and both 2-step and 4-step are configured in AdditionalRACH-Config, the UE applies
the value in the field ssb-perRACH-OccasionAndCB-PreamblesPerSSB in RACH-ConfigCommon in the same
AdditionalRACH-Config. The field is not present when RACH occasions are shared between 2-step and 4-step
type random access in the BWP.
msgA-TotalNumberOfRA-Preambles
Indicates the total number of preambles used for contention-based and contention-free 2-step random access
type when ROs for 2-step are not shared with 4-step. If the field is absent, and 2-step and 4-step does not have
shared ROs, all 64 preambles are available for 2-step random access type.
ra-Prioritization
Parameters which apply for prioritized random access procedure on any UL BWP of SpCell for specific Access
Identities (see TS 38.321, clause 5.1.1a).
rach-ConfigGenericTwoStepRA
2-step random access type parameters for both regular random access and beam failure recovery.

GroupB-ConfiguredTwoStepRA field descriptions

numberOfRA-PreamblesGroupA
The number of CB preambles per SSB in group A for idle/inactive or connected mode. The setting of the number of
preambles for each group should be consistent with msgA-SSB-PerRACH-OccasionAndCB-PreamblesPerSSB or
msgA-CB-PreamblesPerSSB-PerSharedRO if configured.

### RACH-ConfigDedicated

The IE RACH-ConfigDedicated is used to specify the dedicated random access parameters.

### RACH-ConfigDedicated Information Element

| | |
|---|---|
| RACH-ConfigDedicated ::= | SEQUENCE { |
| cfra | CFRA |

OPTIONAL, -- Need S

| | |
|---|---|
| ra-Prioritization | RA-Prioritization |

```
OPTIONAL, -- Need N
  ...,
  [[
```

| | |
|---|---|
| ra-PrioritizationTwoStep-r16 | RA-Prioritization |

OPTIONAL, -- Need N

| | |
|---|---|
| cfra-TwoStep-r16 | CFRA-TwoStep-r16 |

OPTIONAL -- Need S
]]
}

| | |
|---|---|
| CFRA ::= | SEQUENCE { |
| occasions | SEQUENCE { |
| rach-ConfigGeneric | RACH-ConfigGeneric, |
| ssb-perRACH-Occasion | ENUMERATED {oneEighth, oneFourth, oneHalf, one, two, four, |

eight, sixteen}
OPTIONAL -- Cond Mandatory
}
OPTIONAL, -- Need S

| | |
|---|---|
| resources | CHOICE { |
| ssb | SEQUENCE { |
| ssb-ResourceList | SEQUENCE (SIZE(1..maxRA-SSB-Resources)) OF CFRA-SSB- |

Resource,

| | |
|---|---|
| ra-ssb-OccasionMaskIndex | INTEGER (0..15) |

},

| | |
|---|---|
| csirs | SEQUENCE { |
| csirs-ResourceList | SEQUENCE (SIZE(1..maxRA-CSIRS-Resources)) OF CFRA-CSIRS- |

Resource,

| | |
|---|---|
| rsrp-ThresholdCSI-RS | RSRP-Range |

```
    }
  },
  ...,
  [[
```

| | |
|---|---|
| totalNumberOfRA-Preambles | INTEGER (1..63) |

```
OPTIONAL -- Cond Occasions
  ]],
  [[
```

| | |
|---|---|
| msg1-RepetitionNum-r18 | ENUMERATED {n2, n4, n8, spare1} |

OPTIONAL -- Cond 4StepCFRArep
]]
}

| | |
|---|---|
| CFRA-TwoStep-r16 ::= | SEQUENCE { |
| occasionsTwoStepRA-r16 | SEQUENCE { |
| rach-ConfigGenericTwoStepRA-r16 | RACH-ConfigGenericTwoStepRA-r16, |
| ssb-PerRACH-OccasionTwoStepRA-r16 | ENUMERATED {oneEighth, oneFourth, oneHalf, one, |
| | two, four, eight, sixteen} |

```
  }
OPTIONAL, -- Need S
  ...
```

| | |
|---|---|
| resourcesTwoStep-r16 | SEQUENCE { |
| ssb-ResourceList | SEQUENCE (SIZE(1..maxRA-SSB-Resources)) OF CFRA-SSB- |

Resource,

| | |
|---|---|
| ra-ssb-OccasionMaskIndex | INTEGER (0..15) |

```
  },
  ...
}
```

| | |
|---|---|
| CFRA-SSB-Resource ::= | SEQUENCE { |
| ssb | SSB-Index, |
| ra-PreambleIndex | INTEGER (0..63), |

```
  ...,
  [[
```

| | |
|---|---|
| msgA-PUSCH-Resource-Index-r16 | INTEGER (0..3071) OPTIONAL -- Cond 2StepCFRA |

]]
}

| | |
|---|---|
| CFRA-CSIRS-Resource ::= | SEQUENCE { |
| csi-RS | CSI-RS-Index, |
| ra-OccasionList | SEQUENCE (SIZE(1..maxRA-OccasionsPerCSIRS)) OF INTEGER (0..maxRA- |

Occasions−1),

| | |
|---|---|
| ra-PreambleIndex | INTEGER (0..63), |

...
}

CFRA-CSIRS-Resource field descriptions

ra-OccasionList
RA occasions that the UE shall use when performing CF-RA upon selecting the candidate beam identified by this CSI-
RS. The network ensures that the RA occasion indexes provided herein are also configured by prach-
ConfigurationIndex and msg1-FDM. Each RACH occasion is sequentially numbered, first, in increasing order of
frequency resource indexes for frequency multiplexed PRACH occasions; second, in increasing order of time resource
indexes for time multiplexed PRACH occasions within a PRACH slot and Third, in increasing order of indexes for
PRACH slots.
ra-PreambleIndex
The RA preamble index to use in the RA occasions associated with this CSI-RS.

CFRA field descriptions

msg1-RepetitionNum
Indicates the MSG1 repetition number used for contention free 4-step random access type in TS 38.321. If this field is
absent, the UE performs contention free 4-step random access without MSG1-Repetitions.
occasions
RA occasions for contention free random access. If the field is absent, the UE uses the RA occasions configured in
RACH-ConfigCommon in the first active UL BWP.
rach-ConfigGeneric
Configuration of contention free random access occasions for CFRA. The UE shall ignore
preambleReceivedTargetPower, preambleTransMax, powerRampingStep, ra-ResponseWindow signaled within this
field and use the corresponding values provided in RACH-ConfigCommon.
totalNumberOfRA-Preambles
Total number of preambles used for contention free random access in the RACH resources defined in CFRA, excluding
preambles used for other purposes (e.g. for SI request). If the field is absent but the field occasions is present, the UE
may assume all the 64 preambles are for RA. The setting should be consistent with the setting of ssb-perRACH-
Occasion, if present, i.e. it should be a multiple of the number of SSBs per RACH occasion.

CFRA-SSB-Resource field descriptions

ra-PreambleIndex
The preamble index that the UE shall use when performing CF-RA upon selecting the candidate beams identified by
this SSB.
ssb
The ID of an SSB transmitted by this serving cell.

RACH-ConfigDedicated field descriptions

cfra
Parameters for contention free random access to a given target cell. If this field and cfra-TwoStep are absent, the UE
performs contention based random access.
ra-prioritization
Parameters which apply for prioritized random access procedure to a given target cell (see TS 38.321, clause 5.1.1).
ra-PrioritizationTwoStep
Parameters which apply for prioritized 2-step random access type procedure to a given target cell (see TS 38.321,
clause 5.1.1).

### RACH-ConfigGeneric

The IE RACH-ConfigGeneric is used to specify the random-access parameters both for regular random access as well as for beam failure recovery.

### RACH-ConfigGeneric Information Element

| | |
|---|---|
| RACH-ConfigGeneric ::= | SEQUENCE { |
| prach-ConfigurationIndex | INTEGER (0..255), |
| msg1-FDM | ENUMERATED {one, two, four, eight}, |
| msg1-FrequencyStart | INTEGER (0..maxNrofPhysicalResourceBlocks−1), |

...

| | |
|---|---|
| preambleTransMax | ENUMERATED {n3, n4, n5, n6, n7, n8, n10, n20, n50, n100, |

```
n200},
  ...,
  [[
  ...
```

| | |
|---|---|
| prach-ConfigurationIndex-v1610 | INTEGER (256..262) |

OPTIONAL -- Need R
]]
}

RACH-ConfigGeneric field descriptions

msg1-FDM
The number of PRACH transmission occasions FDMed in one time instance. (see TS 38.211, clause 6.3.3.2).
msg1-FrequencyStart
Offset of lowest PRACH transmission occasion in frequency domain with respective to PRB 0. The value is
configured so that the corresponding RACH resource is entirely within the bandwidth of the UL BWP. (see TS
38.211, clause 6.3.3.2).
prach-ConfigurationIndex
PRACH configuration index. For prach-ConfigurationIndex configured under beamFailureRecoveryConfig, the
prach-ConfigurationIndex can only correspond to the short preamble format, (see TS 38.211, clause 6.3.3.2). If
the field prach-ConfigurationIndex-v1610 is present, the UE shall ignore the value provided in prach-
ConfigurationIndex (without suffix).
ra-ResponseWindow
Msg2 (RAR) window length in number of slots. The network configures a value lower than or equal to 10 ms
when Msg2 is transmitted in licensed spectrum and a value lower than or equal to 40 ms when Msg2 is
transmitted with shared spectrum channel access (see TS 38.321, clause 5.1.4). UE ignores the field if included
in SCellConfig. If ra-ResponseWindow-v1610 or ra-ResponseWindow-v1700 is signalled, UE shall ignore the ra-
ResponseWindow (without suffix). The field ra-ResponseWindow-v1700 is applicable to SCS 480 kHz and SCS
960 kHz. The UE shall ignore this field in case rach-ConfigGeneric is included within an EarlyUL-SyncConfig
IE.

### RACH-ConfigGenericTwoStepRA

The IE RACH-ConfigGenericTwoStepRA is used to specify the 2-step random access type parameters.

### RACH-ConfigGenericTwoStepRA Information Element

| | |
|---|---|
| RACH-ConfigGenericTwoStepRA-r16 ::= | SEQUENCE { |
| msgA-PRACH-ConfigurationIndex-r16 | INTEGER (0..262) |

OPTIONAL, -- Cond 2StepOnly

| | |
|---|---|
| msgA-RO-FDM-r16 | ENUMERATED {one, two, four, eight} |

OPTIONAL, -- Cond 2StepOnly

| | |
|---|---|
| msgA-RO-FrequencyStart-r16 | INTEGER (0..maxNrofPhysicalResourceBlocks−1) |

OPTIONAL, -- Cond 2StepOnly
...
}

RACH-ConfigGenericTwoStepRA field descriptions

msgA-PRACH-ConfigurationIndex
Cell-specific PRACH configuration index for 2-step RA type. If the field is absent in RACH-ConfigCommonTwoStepRA
which is configured directly within a BWP (i.e. not within AdditionalRACH-Config), the UE shall use the value of
corresponding 4-step random access parameter in the configured BWP. If the field is absent in RACH-
ConfigCommonTwoStepRA in AdditionalRACH-Config, the UE shall apply the corresponding value in RACH-
ConfigCommon in the same AdditionalRACH-Config. If the value is in the range of 256 to 262, the field prach-
ConfigurationIndex-v1610 should be considered configured (see TS 38.211, clause 6.3.3.2). This field may only be
present if no 4-step type RA is configured in the BWP or in the case of separate ROs with 4-step type RA.
msgA-RO-FDM
The number of msgA PRACH transmission occasions Frequency-Division Multiplexed in one time instance. If the field is
absent in RACH-ConfigCommonTwoStepRA which is configured directly within a BWP (i.e. not within AdditionalRACH-
Config), UE shall use value of msg1-FDM in RACH-ConfigGeneric in the configured BWP. If the field is absent in
RACH-ConfigCommonTwoStepRA in AdditionalRACH-Config, the UE shall apply the value of msg1-FDM in RACH-
ConfigCommon in the same AdditionalRACH-Config (see TS 38.211, clause 6.3.3.2). This field may only be present if
no 4-step type RA is configured in the BWP or in the case of separate ROs with 4-step type RA.
msgA-RO-FrequencyStart
Offset of lowest PRACH transmissions occasion in frequency domain with respect to PRB 0. If the field is absent in
RACH-ConfigCommonTwoStepRA which is configured directly within a BWP (i.e. not within AdditionalRACH-Config),
UE shall use value of msg1-FrequencyStart in RACH-ConfigGeneric in the configured BWP. If the field is absent in
RACH-ConfigCommonTwoStepRA in AdditionalRACH-Config, the UE shall apply the value of msg1-FrequencyStart in
RACH-ConfigCommon in the same AdditionalRACH-Config (see TS 38.211, clauses 5.3.2 and 6.3.3.2). This field may
only be present if no 4-step type RA is configured in the BWP or in the case of separate ROs with 4-step type RA.

### RACH-ConfigTwoTA

The IE RACH-ConfigTwoTA is used to specify random access parameters for each additional PCI configured for the serving cell.

### RACH-ConfigTwoTA Information Element

| | |
|---|---|
| RACH-ConfigTwoTA-r18 ::= | SEQUENCE { |
| rach-ConfigTwoTAIndex-r18 | RACH-ConfigTwoTAIndex-r18, |
| rach-ConfigGeneric-r18 | RACH-ConfigGeneric, |
| ssb-perRACH-Occasion-r18 | ENUMERATED {oneEighth, |
| | oneFourth, oneHalf, one, two, |
| | four, eight, |

```
sixteen} OPTIONAL, -- Need M
  ...
  },
```

| | |
|---|---|
| msg1-SubcarrierSpacing-r18 | SubcarrierSpacing |

OPTIONAL, -- Cond L139
...
}

RACH-ConfigTwoTA field descriptions

rach-ConfigGeneric
RACH parameters for for contention free random access occasions for CFRA.
ssb-perRACH-Occasion
Number of SSBs per RACH occasion.

### RA-Prioritization

The IE RA-Prioritization is used to configure prioritized random access.

### RA-Prioritization Information Element

| | |
|---|---|
| RA-Prioritization ::= | SEQUENCE { |

...

| | |
|---|---|
| scalingFactorBI | ENUMERATED {zero, dot25, dot5, dot75} |

OPTIONAL, -- Need R
...
}

RA-Prioritization field descriptions

scalingFactorBI
Scaling factor for the backoff indicator (BI) for the prioritized random access procedure. (see TS 38.321, clause 5.1.4).
Value zero corresponds to 0, value dot25 corresponds to 0.25 and so on.

### **************************************Quotation End**************************************

In addition, the current RA procedure is specified in TS 38.321 ([5] 3GPP TS 38.321 V18.1.0):

### **************************************Quotation Start [5]**********************************

### 6.1.5 MAC PDU (Random Access Response)

A MAC PDU consists of one or more MAC subPDUs and optionally padding. Each MAC subPDU consists one of the following:
a MAC subheader with Backoff Indicator only;
a MAC subheader with RAPID only (i.e. acknowledgment for SI request);
a MAC subheader with RAPID and MAC RAR.

A MAC subheader with Backoff Indicator consists of five header fields E/T/R/R/BI as described in FIG. 6.1.5-1. A MAC subPDU with Backoff Indicator only is placed at the beginning of the MAC PDU, if included. ‘MAC subPDU(s) with RAPID only’ and ‘MAC subPDU(s) with RAPID and MAC RAR’ can be placed anywhere between MAC subPDU with Backoff Indicator only (if any) and padding (if any).

A MAC subheader with RAPID consists of three header fields E/T/RAPID as described in FIG. 6.1.5-2.

Padding is placed at the end of the MAC PDU if present. Presence and length of padding is implicit based on TB size, size of MAC subPDU(s).

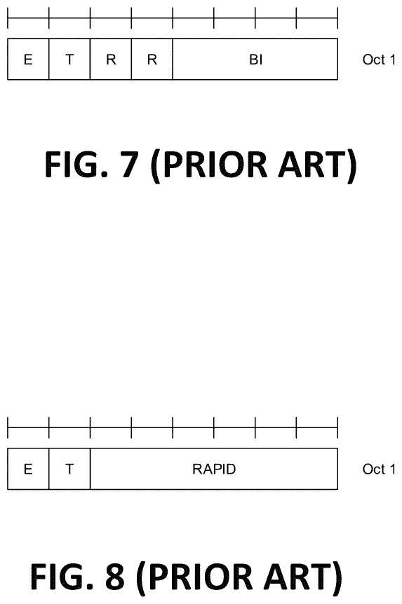

FIG. 7 is a reproduction of FIG. 6.1.5-1: E/T/R/R/BI MAC subheader, from 3GPP TS 38.321 V18.1.0.

FIG. 8 is a reproduction of FIG. 6.1.5-2: ET/RAPID MAC subheader, from 3GPP TS 38.321 V18.1.0.

FIG. 9 is a reproduction of FIG. 6.1.5-3: Example of MAC PDU consisting of MAC RARs, from 3GPP TS 38.321 V18.1.0.

### 6.1.5a MAC PDU (MSGB)

A MAC PDU consists of one or more MAC subPDUs and optionally padding. Each MAC subPDU consists one of the following:
a MAC subheader with Backoff Indicator only;
a MAC subheader and fallbackRAR;
a MAC subheader and successRAR;
a MAC subheader and MAC SDU for CCCH, DCCH or DTCH;
a MAC subheader and padding.

A MAC subheader with Backoff Indicator consists of five header fields E/T1/T2/R/BI as described in FIG. 6.1.5a-1. A MAC subPDU with Backoff Indicator only is placed at the beginning of the MAC PDU, if included.

A MAC subheader for fallbackRAR consists of three header fields E/T1/RAPID as described in FIG. 6.1.5a-2. A MAC subheader for successRAR consists of eight header fields E/T1/T2/S/R/R/R/R as described in FIG. 6.1.5a-3. A MAC subheader for MAC SDU consists of the four header fields R/F/LCID/L as described in FIG. 6.1.2-1 and FIG. 6.1.2-2.

At most one ‘MAC subPDU for successRAR’ indicating presence of ‘MAC subPDU(s) for MAC SDU’ is included in a MAC PDU. MAC subPDU(s) for MAC SDU are placed immediately after the ‘MAC subPDU for successRAR’ indicating presence of ‘MAC subPDU(s) for MAC SDU’.

If MAC PDU includes MAC subPDU(s) for MAC SDU, the last MAC subPDU for MAC SDU is placed before MAC subPDU with padding as depicted in FIG. 6.1.5a4. Otherwise, the last MAC subPDU in MAC PDU is placed before padding as depicted in FIG. 6.1.5a-5. The MAC subPDU with padding includes R/R/LCID MAC subheader as described in FIG. 6.1.2-3 and padding. The size of padding in the MAC subPDU with padding can be zero. The length of padding is implicit based on TB size, size of MAC subPDU(s).

FIG. 10 is a reproduction of FIG. 6.1.5a-1: BI MAC subheader, from 3GPP TS 38.321 V18.1.0.

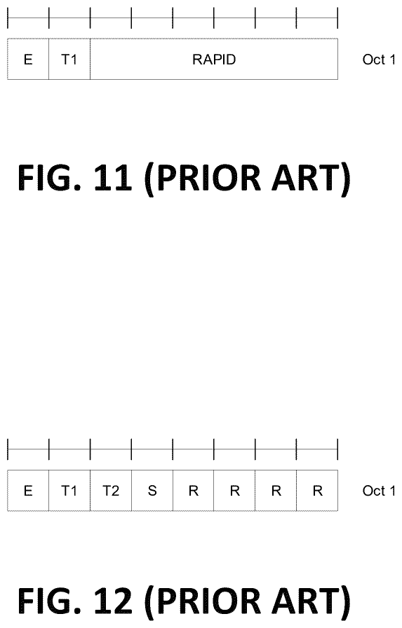

FIG. 11 is a reproduction of FIG. 6.1.5a-2: FallbackRAR MAC subheader, from 3GPP TS 38.321 V18.1.0.

FIG. 12 is a reproduction of FIG. 6.1.5a-3: SuccessRAR MAC subheader, from 3GPP TS 38.321 V18.1.0.

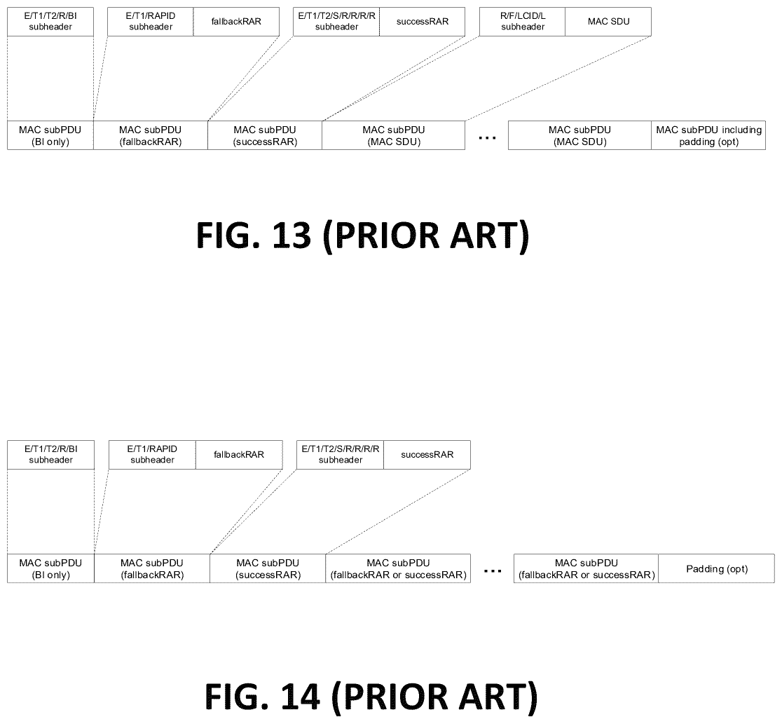

FIG. 13 is a reproduction of FIG. 6.1.5a-4: Example of a MSGB MAC PDU with MAC SDU(s), from 3GPP TS 38.321 V18.1.0.

FIG. 14 is a reproduction of FIG. 6.1.5a-5: Example of a MSGB MAC PDU without MAC SDU(s), from 3GPP TS 38.321 V18.1.0.

### 6.2.2 MAC Subheader for Random Access Response

The MAC subheader consists of the following fields:
E: The Extension field is a flag indicating if the MAC subPDU including this MAC subheader is the last MAC subPDU or not in the MAC PDU. The E field is set to 1 to indicate at least another MAC subPDU follows. The E field is set to 0 to indicate that the MAC subPDU including this MAC subheader is the last MAC subPDU in the MAC PDU;
T: The Type field is a flag indicating whether the MAC subheader contains a Random Access Preamble ID or a Backoff Indicator. The T field is set to 0 to indicate the presence of a Backoff Indicator field in the subheader (BI). The T field is set to 1 to indicate the presence of a Random Access Preamble ID field in the subheader (RAPID);
R: Reserved bit, set to 0;
BI: The Backoff Indicator field identifies the overload condition in the cell. The size of the BI field is 4 bits;
RAPID: The Random Access Preamble Identifier field identifies the transmitted Random Access Preamble (see clause 5.1.3). The size of the RAPID field is 6 bits. If the RAPID in the MAC subheader of a MAC subPDU corresponds to one of the Random Access Preambles configured for SI request, MAC RAR is not included in the MAC subPDU.

The MAC subheader is octet aligned.

### 6.2.2a MAC Subheader for MSGB

The MAC subheader consists of the following fields:
E: The Extension field is a flag indicating if the MAC subPDU including this MAC subheader is the last MAC subPDU (other than MAC subPDU for MAC SDU) or not in the MAC PDU. The E field is set to 1 to indicate at least another MAC subPDU (other than MAC subPDU for MAC SDU) follows. The E field is set to 0 to indicate that the MAC subPDU including this MAC subheader is the last MAC subPDU (other than MAC subPDU for MAC SDU) in the MAC PDU;
T1: The T1 field is a flag indicating whether the MAC subheader contains a Random Access Preamble ID or T2.

The T1 field is set to 1 to indicate the presence of a Random Access Preamble ID field in the subheader (RAPID).

The T1 field is set to 0 to indicate the presence of T2 field in the subheader,
T2: The T2 field is a flag indicating whether the MAC subheader contains a Backoff Indicator (BI) or a MAC SDU indicator (S). The T2 field is set to 0 to indicate the presence of a Backoff Indicator field in the subheader.

The T2 field is set to 1 to indicate the presence of the S field in the subheader,
S: This field indicates whether ‘MAC subPDU(s) for MAC SDU’ follow the MAC subPDU including this MAC subheader or not; The S field is set to 1 to indicate presence of ‘MAC subPDU(s) for MAC SDU’. The S field is set to 0 to indicate absence of ‘MAC subPDU(s) for MAC SDU’;
R: Reserved bit, set to 0;
BI: The Backoff Indicator field identifies the overload condition in the cell. The size of the BI field is 4 bits;
RAPID: The Random Access Preamble IDentifier field identifies the transmitted Random Access Preamble (see clause 5.1.3). The size of the RAPID field is 6 bits.

The MAC subheader is octet aligned.

### 7.2 Backoff Parameter Values

Backoff Parameter values are presented in Table 7.2-1.

TABLE 7.2-1
Backoff Parameter values.

| Index | Backoff Parameter value (ms) |
|---|---|
| 0 | 5 |
| 1 | 10 |
| 2 | 20 |
| 3 | 30 |
| 4 | 40 |
| 5 | 60 |
| 6 | 80 |
| 7 | 120 |
| 8 | 160 |
| 9 | 240 |
| 10 | 320 |
| 11 | 480 |
| 12 | 960 |
| 13 | 1920 |
| 14 | Reserved |
| 15 | Reserved |

### **************************************Quotation End**************************************

Power efficiency has become more critical than ever due to the next-generation network technology's unique characteristics and requirements. One key reason is the tremendous increase in data rate and capacity. Users can experience ultra-fast data transfer speeds, unlocking possibilities for applications like streaming videos, augmented reality, and virtual reality. These bandwidth-intensive tasks place a substantial demand on both User Equipment(s) (UE(s)) and cells, requiring them to transmit and receive data at higher power levels.

Most power-consumption designs focused on UE energy saving since sustaining the power-hungry tasks may drain their batteries. For example, Radio Resource Control (RRC) connected UEs may perform Discontinuous Reception (DRX) to avoid monitoring Physical Downlink Control Channel (PDCCH) continuously. However, the operational cost and the environmental damage caused by base station energy consumption should also be emphasized. It was not until 5G Release 18 that network energy saving techniques were studied and standardized within 3GPP systems.

To facilitate reducing the New Radio (NR) Node B (gNB) downlink transmission/uplink reception active time, the UE can be configured with a periodic cell Discontinuous Transmission (DTX)/DRX pattern. When the cell DTX is configured and activated for the concerned cell, the UE may not monitor PDCCH in selected cases or does not monitor Semi-Persistent Scheduling (SPS) occasions during cell DTX non-active duration. When the cell DRX is configured and activated for the concerned cell, the UE does not transmit on Configured Grant (CG) resources or does not transmit a Scheduling Request (SR) during cell DRX non-active duration. Nevertheless, this feature is only applicable to UEs in RRC_CONNECTED state and it does not impact Random Access (RA) procedures, Synchronization Signal (SS)/Physical Broadcast Channel (PBCH) Block (SSB) transmissions, paging, and system information broadcasting. That is, the energy saving gain may not be efficient. To illustrate the issue, consider the current implementation of RA procedures.

According to the specification, an RA procedure may be initiated by a PDCCH order, by the Medium Access Control (MAC) entity itself, or by RRC. Two types of RA procedure are supported: 4-step RA type with MSG1 and 2-step RA type with MSGA. Both types of RA procedure support Contention-Based Random Access (CBRA) and Contention-Free Random Access (CFRA). The MSG1 of the 4-step RA type consists of a preamble on Physical Random Access Channel (PRACH). After MSG1 transmission, the UE monitors for a response from the network within a configured window. For CFRA, a dedicated preamble for MSG1 transmission is assigned by the network and upon receiving an RA response from the network, the UE ends the RA procedure. For CBRA, upon reception of the RA response, the UE sends MSG3 using the Uplink (UL) grant scheduled in the response and monitors contention resolution. If the contention resolution is not successful after MSG3 (re)transmission(s), the UE goes back to the MSG1 transmission. On the other hand, the MSGA of the 2-step RA type includes a preamble on PRACH and a payload on Physical Uplink Shared Channel (PUSCH). After the MSGA transmission, the UE monitors for a response from the network within a configured window. For CFRA, a dedicated preamble and PUSCH resource are configured for MSGA transmission and upon receiving the network response, the UE ends the RA procedure. For CBRA, if contention resolution is successful upon receiving the network response, the UE ends the RA procedure; while if a fallback indication is received in MSGB, the UE performs the MSG3 transmission using the UL grant scheduled in the fallback indication and monitors the contention resolution. If contention resolution is not successful after the MSG3 (re)transmission(s), the UE goes back to MSGA transmission.

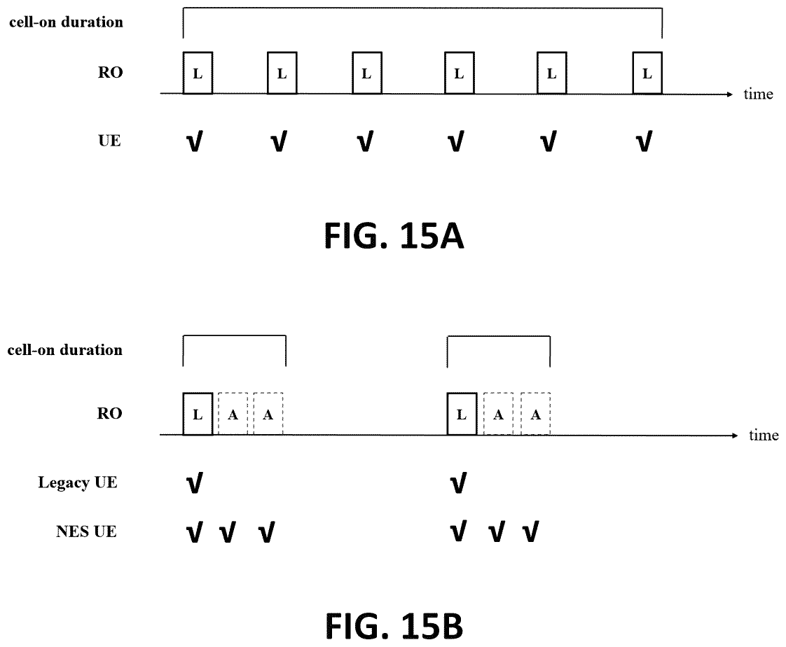

According to the agreements made in RAN1 meeting #116bis ([2] Final Report of 3GPP TSG RAN WG1 #116b v1.0.0) and #117 ([3] Draft Report of 3GPP TSG RAN WG1 #117 v0.2.0), additional PRACH resources may be configured for Network Energy Saving (NES)-capable UEs in purpose of network energy saving. In other words, the Network Energy Saving (NES)-capable UEs could refer to UEs which support PRACH adaptation (in time domain) or can use the additional PRACH resources. Legacy UEs (e.g., non-NES-capable UEs) may only apply legacy PRACH resources, while NES-capable UEs may use both additional and legacy PRACH resources. In other words, the Legacy UEs (e.g., non-NES-capable UEs) could refer to UEs which do not support PRACH adaptation (in time domain) or cannot use the additional PRACH resources. For an example in FIG. 15A, the current implementation of a Random Access Occasion (RO) may result in long turn-on duration for the cell. On the contrary, in FIG. 15B, the adaptation based on additional PRACH resources offers the cell with an opportunity to enter dormancy when there is no PRACH resource provided (e.g., within a time duration). However, from a RAN2 point of view, the configuration of the additional PRACH resources has not been specified. The NES-capable UEs may not use the additional PRACH resources without being configured properly from the network. Therefore, to facilitate network energy saving, the configuration of RA resources needs to be redesigned.

The general concept of the present invention is described in the following.

A UE (e.g., legacy UE, NES UE) in RRC_Connected, RRC_Inactive, and/or RRC_Idle may perform/initiate/trigger an RA procedure. In the RA procedure, the UE may transmit a first transmission to the Network (NW). The NW may transmit a second transmission to the UE in response to reception/detection of the first transmission. In response to or after transmitting the first transmission, the UE may receive a second transmission from the NW. Alternatively, there is no response in response to the first transmission. In other words, the RA procedure is completed in response to transmitting the first transmission. After receiving the second transmission, the UE may or may not transmit a third transmission to the NW. In the case that the UE transmits the third transmission to the NW, the NW may transmit a fourth transmission to the UE in response to reception of the third transmission. In response to or after transmitting the third transmission, the UE may receive a fourth transmission from the NW. If there is a failure in the second transmission and/or the fourth transmission, the UE may or may not perform the first transmission again.

An NES UE may determine (or derive) at least a first configuration (for RA procedure) (e.g., configuration for additional PRACH resources) (associated with an RA procedure) (for (a Bandwidth Part (BWP) of) a cell). The NES UE may determine (or derive) at least a second configuration (for RA procedure) (e.g., configuration for legacy PRACH resources (e.g., RACH-ConfigCommon, RACH-ConfigCommonTwoStepRA, and/or RACH-ConfigDedicated) (associated with the RA procedure) (for (the BWP of) the cell). A legacy UE may determine (or derive) at least the second configuration (e.g., configuration for legacy PRACH resources). The (first and/or second) configuration may be used for a (data or signaling) transmission or reception. The (first and/or second) configuration may be used for an RA procedure. The first configuration may be for NES UE(s). The first configuration may not be for legacy UE(s). The second configuration may be for NES UE(s) and for legacy UE(s).

The (NES) UE may perform an RA procedure (e.g., the first transmission (RA preamble)) based on one or more parameters of the first configuration and one or more parameters of the second configuration. Based on (at least) a purpose of an RA procedure and/or an RO to be used in the RA procedure, the (NES) UE may determine whether to use one or more parameters of the first configuration to perform the RA procedure (e.g., the first transmission (RA preamble)). Based on (at least) a purpose of an RA procedure and/or an RO to be used in the RA procedure, the (NES) UE may determine whether to use one or more parameters of the second configuration to perform the RA procedure (e.g., the first transmission (RA preamble)). For example, when or if (at least) the RA procedure is for a first purpose (e.g., System Information (SI) request (not for Master Information Block (MIB) and/or System Information Block 1 (SIB1)), the UE may use one or more parameters of the second configuration and may not use one or more parameters of the first configuration to perform the RA procedure (e.g., the first transmission (RA preamble)). When or if (at least) the RA procedure is for a second purpose (e.g., initial access or UL data arrival (when UL Timing Advance (TA) is invalid)), the UE may use one or more parameters of the second configuration and one or more parameters of the first configuration to perform the RA procedure (e.g., the first transmission (RA preamble)).

A network node may configure the NES UE with the first configuration by a first method. The network node may provide the first configuration to the NES UE by the first method. The network node may configure the NES UE with the second configuration by a second method. The network node may provide the second configuration to the NES UE by the second method. The network node may configure the legacy UE with the second configuration by the second method. The network node may provide the second configuration to the legacy UE by the second method.

The NES UE may determine (or derive) the first configuration by the first method. The NES UE may determine (or derive) the second configuration by the second method. The NES UE may determine (or apply, or use) a first value for the (first or second) configuration.

The legacy UE may determine (or derive) the second configuration by the second method. The legacy UE may determine (or apply, or use) a second value for the second configuration.

The first method and the second method may be different. The first method and the second method may be the same. The method (e.g., the first method, the second method) may be to receive a common signaling (from network). The UE (e.g., NES UE, legacy UE) may receive a common signaling including at least the (first, second) configuration. The UE may apply the (first, second) configuration in response to receiving the common signaling including the (first, second) configuration. The UE may acquire the (first, second) configuration by the common signaling. The (first, second) configuration may be (or include) a cell-specific configuration. The (first, second) configuration may be (or include) a BWP-specific configuration. The (first, second) configuration may be (or include) a configuration common for multiple UEs, a group of UEs and/or a UE group. The common signaling may be (or include) a broadcast signaling. The common signaling may be received by multiple UEs (or a group of UEs), e.g., in a UE group. The common signaling may be (or include) system information. The common signaling may be (or include) paging. The common signaling may be (or include) any of Radio Resource Control (RRC) signaling (e.g., RRC configuration message), Medium Access Control (MAC) signaling (e.g., MAC Control Element (CE)), or Physical Layer (PHY) signaling (e.g., PDCCH, Downlink Control Information (DCI)).

Alternatively and/or additionally, the method (e.g., the first method, the second method) may be to receive a dedicated signaling (from network). The UE may receive a dedicated signaling including at least the (first, second) configuration. The UE may apply the (first, second) configuration in response to receiving the dedicated signaling including the (first, second) configuration. The UE may acquire the (first, second) configuration by the dedicated signaling. The (first, second) configuration may be (or include) a UE-specific configuration. The (first, second) configuration may be (or include) a configuration dedicated for a (single) UE.

The UE may acquire the first configuration (for (a BWP of) a cell) and the second configuration (for (the BWP of) the cell) from a same cell (e.g., the cell or a second cell). Alternatively, the UE may acquire the first configuration (for (a BWP of) a cell) and the second configuration (for (the BWP of) the cell) from different cells (e.g., the second configuration is from the cell and the first configuration is from a second cell).

Alternatively and/or additionally, the UE may apply (or use) a pre-configured (or pre-defined, or fixed) value for the (first, second) configuration. The UE may apply (or use) a pre-configured (or pre-defined, or fixed) configuration for the (first, second) configuration. The UE may not receive a signaling including at least the (first, second) configuration. The UE may apply (or use) the (first, second) configuration without receiving a signaling including at least the (first, second) configuration. The signaling may be a common signaling and/or a dedicated signaling.

Throughout the present disclosure, when a UE determine a configuration, the UE may require, receive, derive, acquire, determine, store, apply, and/or use the configuration. The second configuration may be a common configuration (e.g., for all UEs) associated with random access procedure. The second configuration may be applied by the legacy UEs and/or the NES UEs. The second configuration may be associated with a (legacy, additional) random access resource (e.g., RO). The UE (legacy UE and/or NES UE) may use (or apply) the (configured) random access resource to perform the first transmission (e.g., Msg1, MSGA) to the network. The second configuration may indicate which random access resource to select for the UE. The second configuration may be (or include) one or more parameter(s) of the following:
Parameter(s) related to SSB (or Channel State Information Reference Signal (CSI-RS));

The parameter(s) may be (or include) any of (and not limited to): a Reference Signal Received Power (RSRP) threshold for SSB (e.g., rsrp-ThresholdSSB, msgA-RSRP-ThresholdSSB, msgA-RSRP-Threshold), a RSRP threshold for CSI-RS (e.g., rsrp-ThresholdCSI-RS), beam failure recovery configuration, resource Identification (ID) (e.g., csi-RS, ssb) and/or ssb-PositionsInBurst,
Parameter(s) related to BWP;

The parameter(s) may be (or include) any of (the following parameters or parameters in the following configurations) (and not limited to): initialUplinkBWP, initialDownlinkBWP, BWP, subcarrierSpacing, BWP-Downlink, BWP-DownlinkCommon, BWP-DownlinkDedicated, BWP-Id, BWP-Uplink, BWP-UplinkCommon and/or BWP-UplinkDedicated,
Parameter(s) related to power;

The parameter(s) may be (or include) any of (and not limited to): messagePowerOffsetGroupB, powerRampingStep, preambleReceivedTargetPower, msgA-PreamblePowerRampingStep and/or msgA-PreambleReceivedTargetPower,
Parameter(s) related to RO;

The parameter(s) may be (or include) any of (and not limited to): ssb-perRACH-OccasionAndCB-PreamblesPerSSB, msgA-CB-PreamblesPerSSB-PerSharedRO, msgA-SSB-PerRACH-OccasionAndCB-PreamblesPerSSB, msgA-SSB-SharedRO-MaskIndex, occasionsTwoStepRA, ra-SSB-OccasionMaskIndex, ssb-PerRACH-OccasionTwoStep and/or RO related in Contention Free Random Access (CFRA) (e.g., ra-OccasionList, ra-PreambleIndex, occasions, ra-ssb-OccasionMaskIndex, ssb-perRACH-Occasion, rach-OccasionsSI),
Parameter(s) related to time;

The parameter(s) may be (or include) any of (and not limited to): ra-ContentionResolutionTimer, ra-ResponseWindow and/or msgB-ResponseWindow,
Parameter(s) related to contention based group;

The parameter(s) may be (or include) any of (and not limited to): ra-Msg3SizeGroupA and/or groupB-ConfiguredTwoStepRA,
Parameter(s) related to RA type transmission resource;

The parameter(s) may be (or include) any of (the following parameters or parameters in the following configurations) (and not limited to): MsgA-ConfigCommon, msgA-PUSCH-Resource-Index and/or msgA-CFRA-PUSCH,
Parameter(s) related to features;

The parameter(s) may be (or include) any of (the following parameters or parameters in the following configurations) (and not limited to): FeatureCombination, FeatureCombinationPreambles and/or featureCombinationPreamblesList,
Parameter(s) related to prioritization;

The parameter(s) may be (or include) any of (the following parameters or parameters in the following configurations) (and not limited to): ra-Prioritization, ra-PrioritizationForAI and/or ra-PrioritizationForSlicing,
Parameter(s) related to physical layer; and/or The parameter(s) may be (or include) any of (and not limited to): msg1-SubcarrierSpacing, msg3-transformPrecoder, prach-RootSequenceIndex, msgA-PRACH-RootSequenceIndex, msgA-SubcarrierSpacing, msg1-FDM, msg1-FrequencyStart, prach-ConfigurationFrameOfset-IAB, prach-ConfigurationPeriodScaling-IAB, prach-ConfigurationSOffset-AB, zeroCorrelationZoneConfig, msgA-RO-FDM, msgA-RO-FrequencyStart and/or msgA-ZeroCorrelationZoneConfig,
Other RA parameter(s);

The parameter(s) may be (or include) any of (the following parameters or parameters in the following configurations) (and not limited to): restrictedSetConfig, msgA-RestrictedSetConfig, msgA-TransMax, msgA-RepetitionNum, cfra-TwoStep and/or preambleTransMax.

The first configuration may include (or be) NES-capable random access configuration(s). The first configuration may be a supplementary (or additional) configuration (e.g., for NES UE) associated with random access procedure. The first configuration may be applied by NES UE(s). The first configuration may not be applied by legacy UE(s). The first configuration may be associated with additional random access resource(s) and/or legacy random access resource(s) (e.g., RO). An NES UE may use (or apply, obtain) the (additional, legacy) random access resource(s) to perform the first transmission (e.g., Msg1, MSGA) to the network. The first configuration may indicate which (legacy and/or additional) random access resource to select for the NES UE. The NES UE may apply a first parameter included in the first configuration to obtain the (additional, legacy) random access resource, if (at least) the first parameter is (explicitly) included in the first configuration. The NES UE may apply a second parameter included in the second configuration to obtain the (additional, legacy) random access resource, if (at least) the second parameter is not (explicitly) included in the first configuration (, and the second parameter is included in the second configuration) (e.g., SSB, BWP). The legacy UE may not apply a first parameter included in the first configuration to obtain the (additional, legacy) random access resource. The first configuration may be (or include) one or more first parameter(s) of the following:
Parameter(s) related to RO;

The parameter(s) may be (or include) any of (and not limited to): number of NES ROs (e.g., ssb-perNES-RACH-OccasionAndCB-PreamblesPerSSB, msgA-SSB-PerNES-RACH-OccasionAndCB-PreamblesPerSSB), NES masking (e.g., NES-ra-ssb-OccasionMaskIndex, NES-msgA-SSB-SharedRO-MaskIndex, SSB-SharedRO-MaskIndex-NFS). For example, the RO number (per SSB) for additional RA resource(s) may not (need to) be the same as the RO number (per SSB) for legacy RA resource(s), if (at least) the RO number for additional RA resource(s) is (explicitly) included in the first configuration. Alternatively and/or additionally, the RO number (per SSB) for additional RA resource(s) may be the same as the RO number (per SSB) for legacy RA resource(s), if (at least) the RO number for additional RA resource(s) is not (explicitly) included in the first configuration (e.g., may be the same in default). For another example, additional RA resource(s) (e.g., RO(s) SSB-to-RO mapping cycle, PRACH association period, PRACH association pattern period) may be masked/skipped if (at least) RO masking configuration for NES is configured. The additional RA resource(s) may not be masked/skipped if (at least) RO masking configuration for NES is not configured. For another example, if (at least) NES PRACH occasions are shared with (e.g., partially or entirely overlap in time domain and/or frequency domain) legacy PRACH occasions, then whether legacy PRACH occasions are available for NES UE may be indicated by the second configuration (e.g., the legacy RO may be available to NES UE if (at least) SSB-SharedRO-MaskIndex-NES is not configured or set to false),
Parameter(s) related to (timing) offset;

The parameter(s) may be (or include) any of (and not limited to): PRACH configuration index (for additional RA resource), scaled/adjusted PRACH configuration period, additional timing offset, adjusted parameters (e.g., (x, y) value and slot number) of the PRACH configuration. For example, if (at least) the PRACH configuration index for the additional PRACH resources is same as the PRACH configuration index for the legacy resource, then the PRACH configuration period/RO timing/(x, y) value/slot number needs to be separated/distinguished from the legacy PRACH configuration period/RO timing/(x, y) value/slot number,
Parameter(s) related to prioritization;

The parameter(s) may be (or include) any of (the following parameters or parameters in the following configurations) (and not limited to): ra-Prioritization, ra-PrioritizationForAI and/or ra-PrioritizationForSlicing,
Parameter(s) related to physical layer; and/or

The parameter(s) may be (or include) any of (and not limited to): msg1-SubcarrierSpacing, msg3-transformPrecoder, prach-RootSequenceIndex, msgA-PRACH-RootSequenceIndex, msgA-SubcarrierSpacing, msg1-FDM, msg1-FrequencyStart, prach-ConfigurationFrameOfset-IAB, prach-ConfigurationPeriodScaling-IAB, prach-ConfigurationSOffset-IAB, zeroCorrelationZoneConfig, msgA-RO-FDM, msgA-RO-FrequencyStart and/or msgA-ZeroCorrelationZoneConfig,
Other RA parameter(s);

The parameter(s) may be (or include) any of (the following parameters or parameters in the following configurations) (and not limited to): restrictedSetConfig, msgA-RestrictedSetConfig, msgA-TransMax, msg1-RepetitionNum, cfra-TwoStep and/or preambleTransMax.

The first configuration may not be (or include) one or more second parameter(s) of the following:
Parameter(s) related to SSB (or CSI-RS);

The parameter(s) may be (or include) any of (and not limited to): a RSRP threshold for SSB (e.g., rsrp-ThresholdSSB, msgA-RSRP-ThresholdSSB, msgA-RSRP-Threshold), a RSRP threshold for CSI-RS (e.g., rsrp-ThresholdCSI-RS), beam failure recovery configuration, resource ID (e.g., csi-RS, ssb) and/or ssb-PositionsInBurst,
Parameter(s) related to BWP;

The parameter(s) may be (or include) any of (the following parameters or parameters in the following configurations) (and not limited to): initialUplinkBWP, initialDownlinkBWP, BWP, subcarrierSpacing, BWP-Downlink, BWP-DownlnkCommon, BWP-DownlinkDedicated, BWP-Id, BWP-Uplink, BWP-UplinkCommon and/or BWP-UplinkDedicated,
Parameter(s) related to power;

The parameter(s) may be (or include) any of (and not limited to): messagePowerOffsetGroupB, powerRampingStep, preambleReceivedTargetPower, msgA-PreamblePowerRampingStep and/or msgA-PreambleReceivedTargetPower,
Parameter(s) related to time;

The parameter(s) may be (or include) any of (and not limited to): ra-ContentionResolutionTimer, ra-ResponseWindow and/or msgB-ResponseWindow,
Parameter(s) related to contention based group;

The parameter(s) may be (or include) any of (and not limited to): ra-Msg3SizeGroupA and/or groupB-ConfiguredTwoStepRA,
Parameter(s) related to RA type transmission resource;

The parameter(s) may be (or include) any of (the following parameters or parameters in the following configurations) (and not limited to): MsgA-ConfigCommon, msgA-PUSCH-Resource-Index and/or msgA-CFRA-PUSCH,
Parameter(s) related to features;

The parameter(s) may be (or include) any of (the following parameters or parameters in the following configurations) (and not limited to): FeatureCombination, FeatureCombinationPreambles and/or featureCombinationPreamblesList,
Parameter(s) related to prioritization;

The parameter(s) may be (or include) any of (the following parameters or parameters in the following configurations) (and not limited to): ra-Prioritization, ra-PrioritizationForAI and/or ra-PrioritizationForSlicing,
Parameter(s) related to physical layer; and/or

The parameter(s) may be (or include) any of (and not limited to): msg1-SubcarrierSpacing, msg3-transformPrecoder, prach-RootSequenceIndex, msgA-PRACH-RootSequenceIndex, msgA-SubcarrierSpacing, msg1-FDM, msg1-FrequencyStart, prach-ConfigurationFrameOfset-IAB, prach-ConfigurationPeriodScaling-IAB, prach-ConfigurationSOffset-AB, zeroCorrelationZoneConfig, msgA-RO-FDM, msgA-RO-FrequencyStart and/or msgA-ZeroCorrelationZoneConfig,
Other RA parameter(s);

The parameter(s) may be (or include) any of (the following parameters or parameters in the following configurations) (and not limit to): restrictedSetConfig, msgA-RestrictedSetConfig, msgA-TransMax, msg1-RepetitionNum, cfra-TwoStep and/or preambleTransMax.

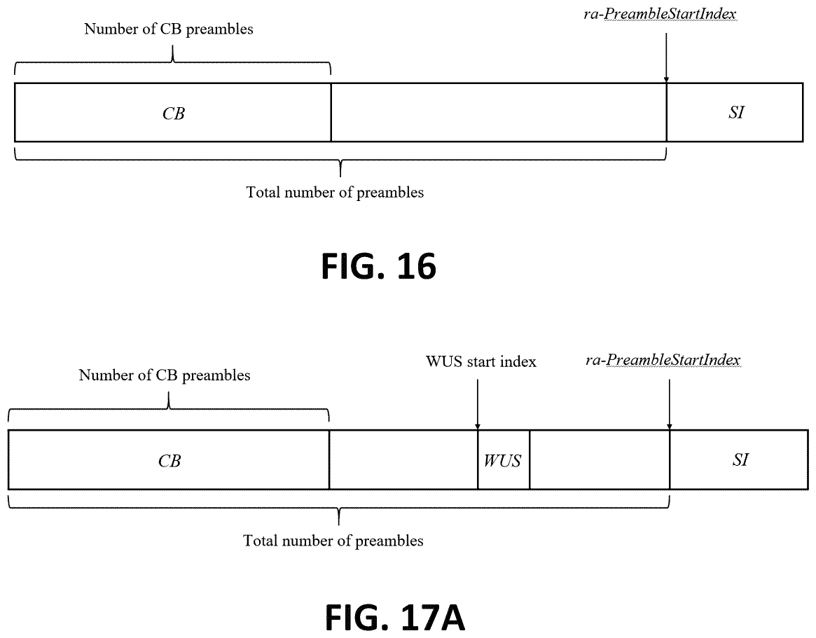

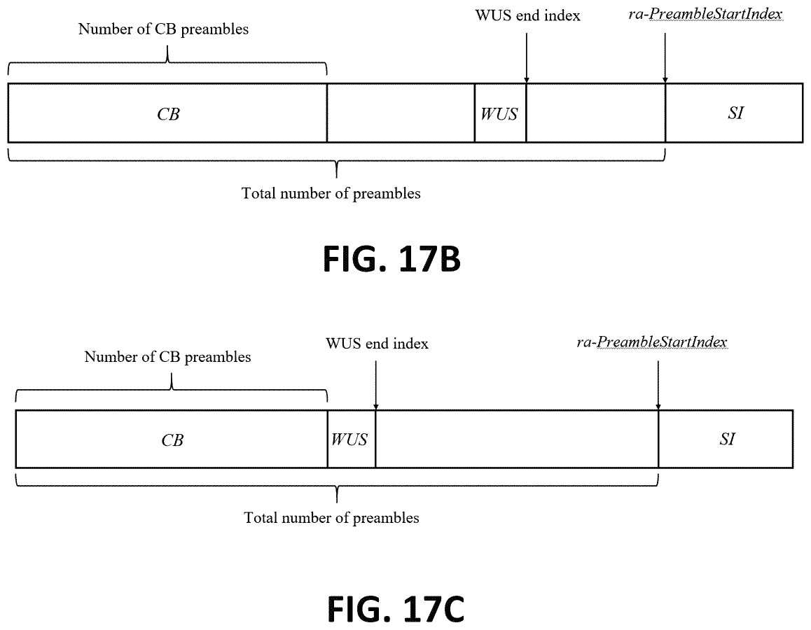

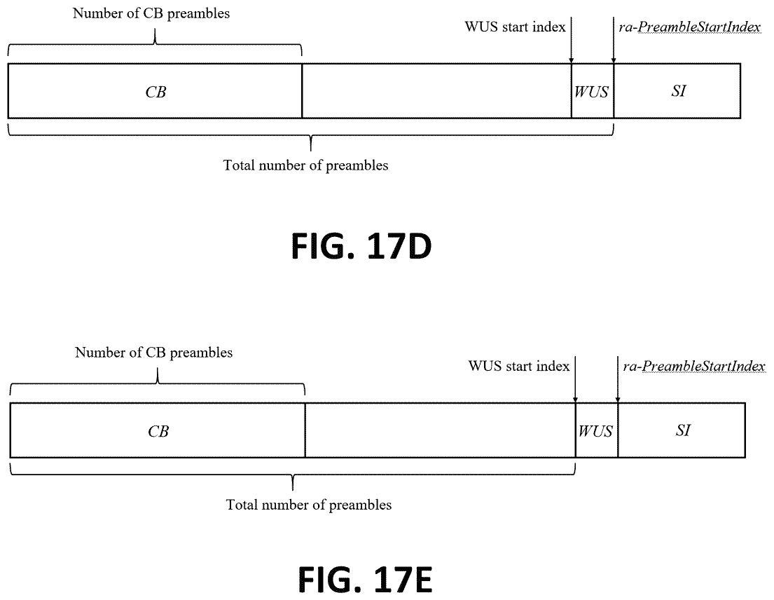

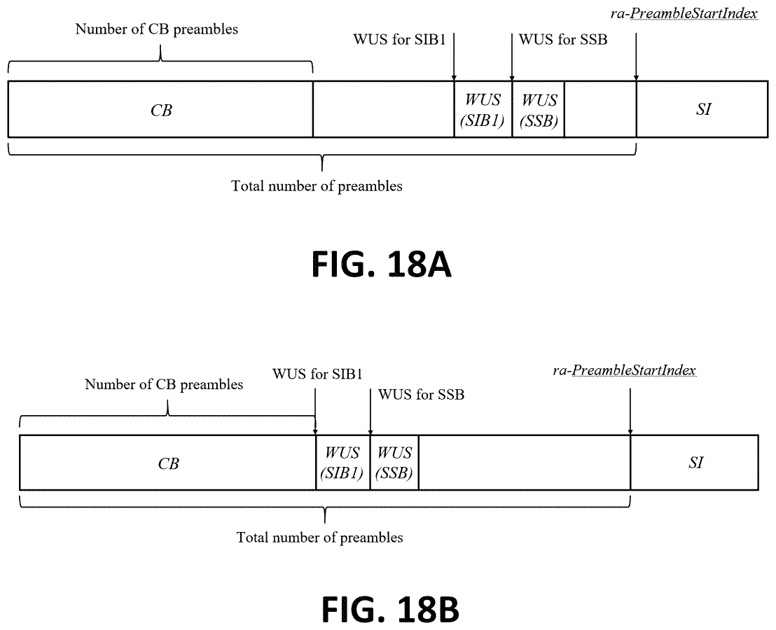

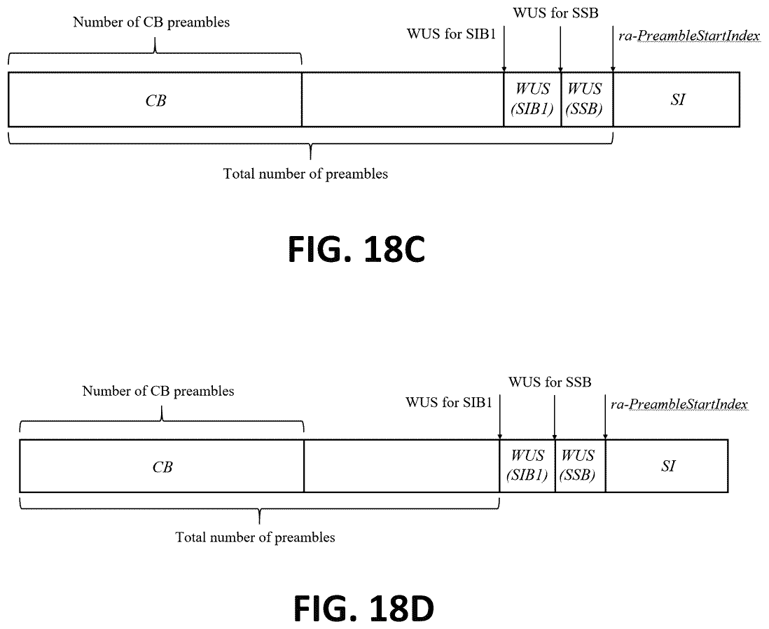

In addition, preamble(s) for random access may or may not be re-designed. The preambles may be partitioned based on the purpose for CBRA, System Information (SI), CFRA and/or Wake-up Signal (WUS) (e.g., for on-demand SSB/SIB1). The preamble(s) for legacy UE and the preamble(s) for NES UE may be the same (e.g., consist of same purposes of preambles; e.g., sequences for different purposes of preamble(s) are the same). The preamble(s) for legacy UEs and the preamble(s) for NES UEs may be different (e.g., legacy UE may apply legacy preamble(s)) as in FIG. 16, and NES UE may apply modified preamble(s) as in FIGS. 17A-18D). The legacy UE may determine one or more parameter(s) related to preamble(s) from the second configuration. The NES UE may determine one or more parameter(s) related to preamble(s) from the first configuration and/or the second configuration. The parameter(s) related to preamble may be included in the first configuration only (and not included in the second configuration). The parameter(s) related to preamble may be included in the second configuration only (and not included in the first configuration). The parameter(s) related to preamble may be included in both the first configuration and the second configuration (and with the same value). The parameter(s) related to preamble may be included in both the first configuration and the second configuration (and with different values). The parameter(s) may be (or include) one or more of the following(s) (but not limited to):
Number of preambles for CBRA;

The number of preambles for CBRA (to be used in RO(s)) may include the number of contention based preamble(s). The total number of preambles may include the number of contention free preamble(s). The total number of preambles may or may not include the number of preamble(s) for WUS. The total number of preambles may or may not be a legacy parameter (e.g., CB-PreamblesPerSSB),

The parameter may be applied by the legacy UE. The parameter may be applied by the NES UE. The parameter may be included in the second configuration only (and not included in the first configuration). Alternatively and/or additionally, the parameter may be included in both the first configuration and the second configuration. If (at least) the parameters are included in both the first configuration and the second configuration, the value of the parameters may (need to) be the same. If (at least) the parameters are included in both the first configuration and the second configuration, the value of the parameters may not be different,
Total number of preambles;

The total number of preambles (to be used in RO(s)) may include the number of contention based preamble(s). The total number of preambles may include the number of contention free preamble(s). The total number of preambles may or may not include the number of preamble(s) for WUS. The total number of preambles may or may not be a legacy parameter (e.g., totalNumberOfRA-Preambles),

The parameter(s) may be applied by the legacy UE. The parameter(s) may be applied by the NES UE. The parameter (with a single value) may be included in the second configuration only (and not included in the first configuration). The legacy UE and/or the NES UE may apply the (same) value for the parameter. Alternatively and/or additionally, the parameter(s) (with more than one values for different types of UE) may be included in the second configuration only (and not included in the first configuration). The parameter(s) for different types of UE may be separated explicitly (e.g., indicate each value with different indices) or implicitly (e.g., the first value is for legacy UE, and the second value is for NES UE). The legacy UE and the NES UE may apply different values for each parameter respectively. Alternatively and/or additionally, the (more than one) parameters may be included in both the first configuration and the second configuration. The (more than one) parameters included in both the first configuration and the second configuration may or may not be the same. The legacy UE may apply a (first) value included in the second configuration. The NES UE may apply a (second) value included in the first configuration,
WUS start index and/or WUS end index; and/or

The WUS start index may indicate the starting location (index) of the preamble for WUS. The WUS end index may indicate the ending location (index) of the preamble for WUS. The WUS start index and the WUS end index may be both configured. The WUS start index and the WUS end index may not be both configured (e.g., WUS start index may be solely configured as in FIGS. 17A, 17D, 17E; e.g., WUS end index may be solely configured as in FIGS. 17B, 17C),

The parameter(s) may not be applied by the legacy UE. The parameter(s) may be applied by the NES UE. The parameter(s) may be included in the second configuration only (and not included in the first configuration). Alternatively and/or additionally, the parameter(s) may be included in the first configuration only (and not included in the second configuration),
WUS index for SSB and/or WUS index for SIB1;

The WUS may be applied for SSB request and/or SIB1 request. The WUS for SSB request and the WUS for SIB1 request may not be both configured. The WUS for SSB request and the WUS for SIB1 request may be both configured (e.g., as in FIGS. 18A-18D),

The parameter(s) may not be applied by the legacy UE. The parameter(s) may be applied by the NES UE. The parameter(s) may be included in the second configuration only (and not included in the first configuration). Alternatively and/or additionally, the parameter(s) may be included in the first configuration only (and not included in the second configuration).

The second configuration may indicate a first number of preambles for CBRA (for (a BWP of) a cell). The second configuration may indicate a second number of preambles for CBRA (for (the BWP of) the cell). Alternatively, the second configuration may indicate no number of preambles for CBRA except for the first number of preambles for CBRA (for (the BWP of) the cell). The first configuration may indicate a second number of preambles for CBRA (for (the BWP of) the cell). Alternatively, the first configuration may not indicate any number of preambles for CBRA (for (the BWP of) the cell). The first number may be used by the (e.g., legacy, NES) UE to determine a preamble index to be used in RO(s) indicated by the second configuration. The first number may be used by the UE to determine a preamble index to be used in RO(s) indicated by the first configuration (e.g., when the second number is not indicated or does not exist). Alternatively, the second number may be used by the (e.g., NES) UE to determine a preamble index to be used in RO(s) indicated by the first configuration. The first number may not be used by the UE to determine a preamble index to be used in RO(s) indicated by the first configuration. The first number may be different from the second number. Alternatively, the first number may be the same as the second number. The network may not be allowed to configure, to a (NES) UE, the first number and the second number with different values.

The second configuration may indicate a first total number of preambles (for (a BWP of) a cell). The second configuration may indicate a second total number of preambles (for (the BWP of) the cell). Alternatively, the second configuration may indicate no total number of preambles except for the first total number of preambles (for (the BWP of) the cell). The first configuration may indicate a second total number of preambles (for (the BWP of) the cell). Alternatively, the first configuration may not indicate any total number of preambles (for (the BWP of) the cell). The first total number may be used by the (e.g., legacy, NES) UE to determine a preamble index to be used in RO(s) indicated by the second configuration. The first total number may be used by the UE to determine a preamble index to be used in RO(s) indicated by the first configuration (e.g., when the second total number is not indicated or does not exist). Alternatively, the second total number may be used by the (e.g., NES) UE to determine a preamble index to be used in RO(s) indicated by the first configuration. The first total number may not be used by the UE to determine a preamble index to be used in RO(s) indicated by the first configuration. The first total number may be different from the second total number. Alternatively, the first total number may be the same as the second total number. The network may not be allowed to configure, to a (NES) UE, the first total number and the second total number with different values.

The second configuration may indicate a starting index of preambles for requesting SSB and/or SIB1 transmission(s). The first configuration may not indicate the starting index of preambles for requesting SSB and/or SIB1 transmission(s). Alternatively, the first configuration may indicate a starting index of preambles for requesting SSB and/or SIB1 transmission(s). The second configuration may not indicate the starting index of preambles for requesting SSB and/or SIB1 transmission(s). Alternatively, the starting index may be (derived from or based on) the first number or the second number. Alternatively, the starting index may be (derived from or based on) the first total number or the second total number.

The second configuration may indicate an ending index of preambles for requesting SSB and/or SIB1 transmission(s). The first configuration may not indicate the ending index of preambles for requesting SSB and/or SIB1 transmission(s). Alternatively, the first configuration may indicate an ending index of preambles for requesting SSB and/or SIB1 transmission(s). The second configuration may not indicate the ending index of preambles for requesting SSB and/or SIB1 transmission(s). Alternatively, the ending index may be (derived from or based on) the first total number or the second total number. Alternatively, the ending index may be (derived from or based on) the ra-PreambleStartIndex (e.g., ra-PreambleStartIndex-1).

The second configuration may indicate at least one preamble index for requesting SSB and/or SIB1 transmission(s). The first configuration may not indicate the at least one preamble index for requesting SSB and/or SIB1 transmission(s). Alternatively, the first configuration may indicate at least one preamble index for requesting SSB and/or SIB1 transmission(s). The second configuration may not indicate the at least one preamble index for requesting SSB and/or SIB1 transmission(s).

The starting index, the ending index, and/or the at least one preamble index may be used by the UE to determine a preamble index (for requesting SSB and/or SIB1 transmission(s)) to be used in RO(s) indicated by the first configuration. The starting index, the ending index, and/or the at least one preamble index may be used by the UE to determine a preamble index (for requesting SSB and/or SIB1 transmission(s)) to be used in RO(s) indicated by the second configuration. Alternatively, the starting index, the ending index, and/or the at least one preamble index may not be used by the UE to determine a preamble index (for requesting SSB and/or SIB1 transmission(s)) to be used in RO(s) indicated by the second configuration.

The network may be allowed to include the one or more first parameters in the first configuration transmitted to the UE. The Network may be not allowed to include the one or more second parameters in the first configuration transmitted to the UE.

One or more of the above embodiment(s), concept(s), method(s), and/or example(s) for the first configuration and/or the second configuration could be combined, in whole or in part.

An NES UE may determine (or derive) an RO after determining an SSB and/or a preamble (index) for transmission (e.g., Msg1, MSGA). The NES UE may be configured with (one or more) RO(s) from the first configuration and/or the second configuration (e.g., corresponding to the determined SSB). The NES UE may determine (exactly) one RO from the configured RO(s), if (at least) more than one RO is configured. The NES UE may determine (exactly) one RO based on a first factor.

The first factor may be or include configuration(s) related to masking. For example, the first factor may be (or include) any of (and not limited to) the masking-related parameters: ra-ssb-OccasionMaskIndex, msgA-SSB-SharedRO-MaskIndex, SSB-SharedRO-MaskIndex (and/or NES-ra-ssb-OccasionMaskIndex, NES-msgA-SSB-SharedRO-MaskIndex, SSB-SharedRO-MaskIndex-NES). The (NES) UE may determine whether to select an RO from RO(s) indicated by the second configuration based on (at least) masking-related parameter(s) of the second configuration (and not based on masking-related parameter(s) of the first configuration). The (NES) UE may determine whether to select an RO from RO(s) indicated by the first configuration based on (at least) masking-related parameter(s) of the first configuration (and not based on masking-related parameter(s) of the second configuration). Alternatively, the (NES) UE may determine whether to select an RO from RO(s) indicated by the first configuration based on (at least) masking-related parameter(s) of the first configuration and masking-related parameter(s) of the second configuration. Alternatively, the (NES) UE may determine whether to select an RO from RO(s) indicated by the first configuration based on (at least) masking-related parameter(s) of the second configuration (e.g., masking-related parameter(s) is not (allowed to be) present or included in the first configuration). The NES UE may not select an RO if (at least) the masking-related parameter(s) is configured, and the RO is indicated, prohibited, or masked in the configured masking-related parameter(s). The NES UE may (be able to) select the RO if (at least) the masking-related parameter(s) is not configured. The NES UE may (be able to) select the RO if (at least) the masking-related parameter(s) is configured, and the RO is not indicated, prohibited, or masked in the configured masking-related parameter(s).

The first factor may be or include time duration(s). For example, the first factor may be (or include) any of (and not limited to) the time durations: measurement gaps, MUSIM gaps. The NES UE may not select an RO if (at least) the RO is overlapped with (any of) the time duration(s). The NES UE may select the RO if (at least) the RO is not overlapped with (any of) the time duration(s).

The first factor may be or include a (first, second, third) purpose of the RA procedure. The purpose(s) of the RA procedure may be/include any of the following events: SI request (Msg1-based), SI request (Msg3-based), initial access from RRC_IDLE, RRC Connection Re-establishment procedure, Downlink (DL) data arrival, UL data arrival, handover, Scheduling Request (SR) failure, explicit request by RRC upon synchronous reconfiguration, RRC Connection Resume procedure from RRC_INACTIVE, to establish time alignment for a primary or a secondary Timing Advance Group (TAG), beam failure recovery, UL Listen Before Talk (LBT) failure, Small Data Transmission (SDT), positioning, early UL synchronization with an Layer 1 (L1)/Layer 2 (L2)-Triggered Mobility (LTM) candidate cell, and/or RACH-based LTM cell switch. The network may configure (separate) RA resources for a (certain) purpose of the RA procedure. When or if (at least) the UE starts/initiates/triggers the RA procedure for the (certain) purpose, the UE may derive/select the (separate) resources. When or if (at least) the UE starts/initiates/triggers the RA procedure for other purposes (except for the certain purpose), the UE may not (be allowed to) derive/select the (separate) resources. To reduce signaling (or message) overhead, and/or for efficient resource allocation, the network may (only need to) configure/provide the (separate) RA resources for the (certain) purpose by (exactly) one configuration (e.g., only in the first configuration or only in the second configuration.) For example, the resources for a Msg1-based SI request are contention-free. If the network configures the resources for a Msg1-based SI request in both the first configuration and the second configuration, the legacy UE may select an RO in the first configuration and the NES UE may select an RO in the second configuration. In this case, there would be redundant Random Access Responses (RARs). Therefore, the resources for a Msg1-based SI request may not (need to) be configured in both the first configuration and the second configuration.

For example, when or if (at least) the RA procedure is for a first purpose (e.g., SI request (not for MIB and/or SIB1) (Msg1-based and/or Msg3-based)), the UE may be allowed to select an RO from RO(s) indicated by the second configuration and may not be allowed to select an RO from RO(s) indicated by the first configuration. When or if (at least) the RA procedure is for a second purpose (e.g., initial access or UL data arrival (when UL TA is invalid)), the UE may be allowed to select an RO from RO(s) indicated by the first configuration and RO(s) indicated by the second configuration. When or if (at least) the RA procedure is for a third purpose (e.g., request for SIB1 and/or SSB transmission(s)), the UE may be allowed to select an RO from RO(s) indicated by the first configuration and may not be allowed to select an RO from RO(s) indicated by the second configuration. An event may be/belong to (exactly) one of the (first, second, third) purpose(s) (of the RA procedure). If (at least) the event is/belongs to a (e.g., first) purpose, the event may not be/belong to other (e.g., second, third) purposes. For example, the Msg1-based SI request may (only) be/belong to the first purpose, and may not be/belong to the second purpose or the third purpose. For another example, initial access may (only) be/belong to the second purpose, and may not be/belong to the first purpose or the third purpose.

The first factor may be a random selection. For example, the NES UE may select a PRACH occasion randomly with equal probability amongst the available PRACH occasions (e.g., not masked or prohibited).

The first factor may not be the type of RO (i.e. whether the RO is legacy RO or additional RO), if (at least) not indicated by the network (explicitly). For example, the NES UE may select a PRACH occasion randomly with equal probability amongst available legacy PRACH occasion(s) and additional PRACH occasion(s). The NES UE may not prioritize additional RO(s) over legacy RO(s), if (at least) not indicated by the network (explicitly) (e.g., all legacy ROs are masked). That is, the NES UE may not select an additional RO with higher probability amongst all available ROs (nor may the NES UE always select an additional RO). Alternatively and/or additionally, the NES UE may not prioritize legacy RO(s) over additional RO(s), if (at least) not indicated by the network (explicitly) (e.g., all additional ROs are masked). That is, the NES UE may not select a legacy RO with higher probability amongst all available ROs (nor may the NES UE always select a legacy RO).

In the above embodiment(s), when or if (at least) the UE does not (or is not allowed to) select an RO from RO(s) indicated by a (e.g., first, second) configuration, the network may or may not include resources (e.g., ROs, preamble (index), SSB-to-RO mapping) in the (e.g., first, second) configuration for the UE. The UE may or may not (be able to) derive an RO from the (e.g., first, second) configuration.

In the above embodiment(s), when or if (at least) a UE (is allowed to) derives (or selects) an RO for a (specific) PRACH resource from the first configuration, the (specific) PRACH resource may be applied to (time-domain) PRACH adaptation. When or if (at least) the UE is not allowed to derive (or select) an RO for the (specific) PRACH resource from the first configuration, the (specific) PRACH resource may not be applied to (time-domain) PRACH adaptation. The specific PRACH resource may be/include (at least) any of: CBRA resources, CFRA resources, Msg1-based SI request resources, Integrated Access Backhaul (IAB) resources.

One or more of the above embodiment(s), concept(s), method(s), and/or example(s) for the first factor could be combined, in whole or in part.

Throughout the present disclosure, the following terms may be interchanged: “NES UE”, “NES-capable UE”, “UE supporting RACH adaptation”, “UE supporting PRACH adaptation”, “UE supporting RACH adaptation in time domain”, and/or “UE supporting PRACH adaptation in time domain”.

Throughout the present disclosure, the “RO” may be replaced by “RACH occasion” and/or “PRACH occasion”.

Throughout the present disclosure, the “additional RO” may be replaced by “NES RO”, “additional RA resource”, and/or “additional PRACH resource”.

Throughout the present disclosure, the “RA resource” may be replaced by “RO”, “preamble”, and/or “PRACH resource”.

Throughout the present disclosure, the “PRACH” may be replaced by “channel for random access”.

Throughout the present disclosure, the “RACH” may be replaced by “access channel”.

The UE may be referred to the UE, an RRC layer of the UE, a MAC entity of the UE, or physical layer of the UE.

The network may be a network node. The network (node) may be a base station. The network (node) may be an access point. The network (node) may be an evolved Node B (eNB). The network (node) may be a gNB.

Various examples and embodiments of the present invention are described below. For the methods, alternatives, concepts, examples, and embodiments detailed above and herein, the following aspects and embodiments are possible.

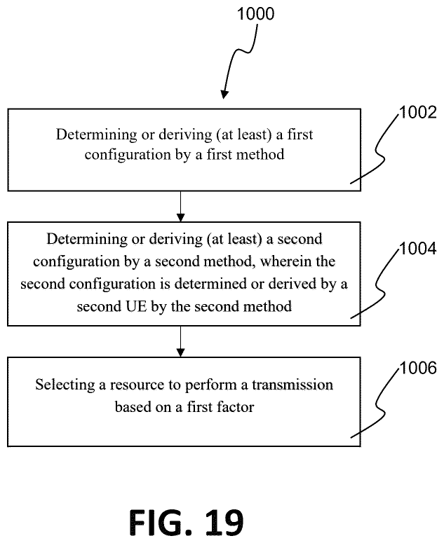

Referring to FIG. 19, with this and other concepts, systems, and methods of the present invention, a method 1000 for a first UE in a wireless communication system comprises determining or deriving (at least) a first configuration by a first method (step 1002), determining or deriving (at least) a second configuration by a second method, wherein the second configuration is determined or derived by a second UE by the second method (step 1004), and selecting a resource to perform a transmission based on a first factor (step 1006).

In various embodiments, the first UE is an NES-capable UE.

In various embodiments, the second UE is a legacy UE.

In various embodiments, the first UE determines or derives a first value for the first configuration.

In various embodiments, the first UE determines or derives a second value for the second configuration.

In various embodiments, the second UE determines or derives a third value for the second configuration.

In various embodiments, the first method or the second method is to receive a common signaling from a network node.

In various embodiments, the first method or the second method is to receive a dedicated signaling from a network node.

In various embodiments, the first configuration includes a configuration related to RO.

In various embodiments, the first configuration includes a configuration related to timing offset.

In various embodiments, the first configuration includes a configuration related to preamble.

In various embodiments, the second configuration includes a configuration related to SSB or CSI-RS.

In various embodiments, the second configuration includes a configuration related to BWP.

In various embodiments, the second configuration includes a configuration related to preamble.

In various embodiments, the second configuration includes a configuration related to RA besides preamble/RO/timing offset.

In various embodiments, the resource is a random access occasion.

In various embodiments, the first factor includes a parameter related to masking.

In various embodiments, the first factor includes a time duration.

In various embodiments, the first factor includes a random selection.

In various embodiments, the first factor does not include whether the RO is a legacy RO or additional RO.

In various embodiments, the transmission is a Msg1 or MSGA.

Referring back to FIGS. 3 and 4, in one or more embodiments from the perspective of a first UE in a wireless communication system, the device 300 includes a program code 312 stored in memory 310 of the transmitter. The CPU 308 could execute program code 312 to: (i) determine or derive (at least) a first configuration by a first method; (ii) determine or derive (at least) a second configuration by a second method, wherein the second configuration is determined or derived by a second UE by the second method; and (iii) select a resource to perform a transmission based on a first factor. Moreover, the CPU 308 can execute the program code 312 to perform all of the described actions, steps, and methods described above, below, or otherwise herein.

According to the specification, an RA procedure may be initiated by a PDCCH order, by the MAC entity itself, or by RRC. Two types of RA procedure are supported: 4-step RA type with Msg1 and 2-step RA type with MSGA. Both types of RA procedure support CBRA and CFRA. The MSG1 of the 4-step RA type consists of a preamble on PRACH. After the Msg1 transmission, the UE monitors for a response from the network within a configured (time) window. For CFRA, a dedicated preamble for Msg1 transmission is assigned by the network and upon receiving a random access response from the network, the UE ends the RA procedure. For CBRA, upon reception of the RA response, the UE sends a Msg3 using the UL grant scheduled in the response and monitors contention resolution. On the other hand, the MSGA of the 2-step RA type includes a preamble on PRACH and a payload on PUSCH. After the MSGA transmission, the UE monitors for a response from the network within a configured window. For CFRA, a dedicated preamble and PUSCH resource are configured for a MSGA transmission and upon receiving the network response, the UE ends the RA procedure. For CBRA, if contention resolution is successful upon receiving the network response, the UE ends the RA procedure. In contrast, if a fallback indication is received in MSGB, the UE performs MSG3 transmission using the UL grant scheduled in the fallback indication and monitors contention resolution. For 4-step RA, if the reception of the RA response is not successful, or if contention resolution fails after the Msg3 (re)transmission(s), the UE may go back to a Msg1 (re)transmission. Similarly, for 2-step RA, if the reception of MSGB is not successful, or if contention resolution fails after Msg3 (re)transmission(s), the UE may go back to MSGA or Msg1 (re)transmission.

According to the agreements made in RAN1 meeting #116bis ([2] Final Report of 3GPP TSG RAN WG1 #116b v1.0.0) and #117 ([3] Draft Report of 3GPP TSG RAN WG1 #117 v0.2.0), additional PRACH resources may be configured for NES-capable UEs in purpose of network energy saving. Legacy UEs may only apply legacy PRACH resources, while NES-capable UEs may use both additional and legacy PRACH resources. For an example in FIG. 15A, the current implementation of RO may result in long turn-on duration for the cell. To the contrary in FIG. 15B, the adaptation based on additional PRACH resources offers the cell with an opportunity to enter dormancy when there is no PRACH resource provided (e.g., within a time duration). After the UE performs Msg1 (or MSGA) transmission within an RO, the reception of an RA response (or MSGB) may be unsuccessful for some UE(s) (e.g., does not receive RAR including a corresponding Random Access Preamble Identifier (RAPID)). The UE(s) which does not receive RAR (or MSGB) successfully may perform Msg1 (or MSGA) (re)transmission after a backoff time, which is derived from an indication in RAR (or MSGB) and a configured scaling factor (e.g., a random value from a uniform distribution). The backoff time is designed to decrease the possibility of contention.

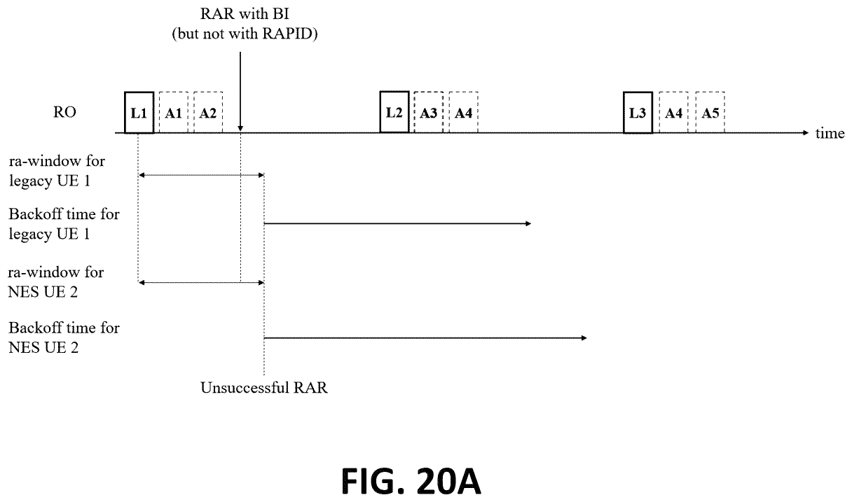

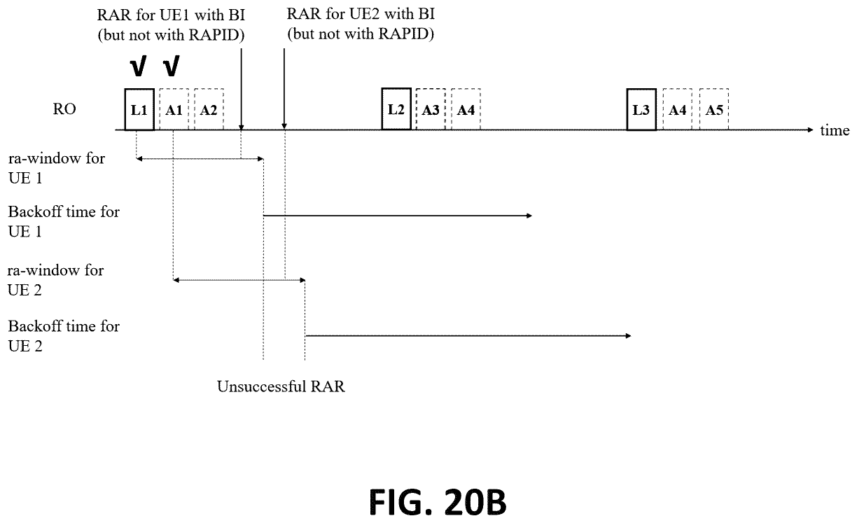

However, given the different accessibility of legacy ROs and additional ROs, there may be a lack of efficiency with a single backoff time applied solely. For example, in FIG. 20A, a legacy UE (UE1) and an NES UE (UE2) both select a legacy RO (L1) to perform Msg1 transmission. If (at least) both UEs do not receive RAR corresponding to their RAPID upon the expiry (expiration) of the RAR window, and there is a Backoff Indicator (BI) factor included in the received RAR, they select a backoff time respectively. The backoff time is determined from selecting a random value with equal probability between 0 and PREAMBLE_BACKOFF, of which the value is “(a same) BI field (in the RAR)” multiplied by “(a same) scaling factor”. That is, the value of PREAMBLE_BACKOFF is the same for UE1 and UE2. UE1 may not select L2 to perform Msg1 transmission. UE2 may not select L2, A3, nor A4 to perform Msg1 transmission. However, since the NES UE may have access to additional ROs and legacy ROs, it may not require such a long backoff time to avoid collision. In other words, the long backoff time (as UE1 has) may cause UE2 to be unable to use ROs (e.g., L2, A3, A4), even when using these ROs may not necessarily lead to collision.

For another example, in FIG. 20B, a legacy UE (UE1) selects a legacy RO (L1), and an NES UE (UE2) selects an additional RO (A1) to perform Msg1 transmission. If (at least) both UEs do not receive RAR corresponding to their RAPID upon the expiry of the RAR window, and there is a BI factor included in the received RAR respectively, they select a backoff time respectively. The backoff time is determined from selecting a random value with equal probability between 0 and PREAMBLE_BACKOFF, of which the value is “BI field (in each RAR)” multiplied by “(a same) scaling factor”. UE2 (accessed to A1) may derive a BI field different from UE1 does to avoid the same (long) backoff time. However, the differentiated BI field may not be specified in the current implementation.

In order to improve the efficiency in re-selecting RA resources, the backoff mechanism needs to be re-designed.

The general concept in the present invention can be described as follows.

A UE (e.g., legacy UE, NES UE) in RRC_Connected, RRC_Inactive, and/or RRC_Idle may perform/initiate/trigger an RA procedure. In the RA procedure, the UE may transmit a first transmission to the NW. The NW may transmit a second transmission to the UE in response to reception/detection of the first transmission. In response to or after transmitting the first transmission, the UE may receive a second transmission from the NW. After receiving the second transmission, the UE may or may not transmit a third transmission to the NW. In the case that the UE transmits the third transmission to the NW, the NW may transmit a fourth transmission to the UE in response to reception of the third transmission. In response to or after transmitting the third transmission, the UE may receive a fourth transmission from the NW. If there is failure in the second transmission and/or the fourth transmission, the UE may or may not perform the first transmission again.

The (e.g., legacy, NES) UE may perform the first transmission by selecting (or determining) a random access resource (e.g., preamble, RO). The random access resource may be determined by a (first or second) configuration configured by the network. The UE may determine (derive) an ID (e.g., RA-Radio Network Temporary Identifier (RNTI) or MSGB-RNTI) from the (determined) random access resource. After (or in response to) performing the first transmission, the UE may start a timer (e.g., ra-Response Window, msgB-ResponseWindow) configured in the (first or second) configuration. The UE may monitor (e.g., on PDCCH) an indication (e.g., Cell-RNTI (C-RNTI), RA-RNTI or MSGB-RNTI) from the network with the timer running. The UE may receive and decode a response of the second transmission associated with the ID (e.g., RA-RNTI, MSGB-RNTI). In this case, if (at least) a field (e.g., Backoff Indicator) is included in the (received and decoded) response, the UE may determine a backoff parameter (e.g., PREAMBLE BACKOFF) from the field. The backoff parameter may be determined from a scaling parameter included in the (first or second) configuration. For example, the backoff parameter may be the multiplication of “a value mapped to the field” and “the scaling parameter”. If (at least) the field is not included in the (received and decoded) response, the backoff parameter may be 0.

The reception of the second transmission may be considered successful if (at least) the (received and decoded) response includes an identifier (e.g., RAPID) corresponding to the (determined) random access resource (e.g., PREAMBLE_INDEX) with the timer running. The reception of the second transmission may be considered unsuccessful if (at least) the response including the identifier corresponding to the random access resource is not received upon the expiry of the timer. A backoff time may be selected randomly from a uniform distribution between 0 and the backoff parameter. The UE may perform the first (re)transmission if (at least) the reception (of the response) is not successful, and the random access procedure is not completed. The UE may perform the first (re)transmission after the backoff time. The UE may perform the first (re)transmission if (at least) the criteria (as defined in 38.321 5.1.2a) to select contention-free Random Access Resources is met during the backoff time.

Throughout the present disclosure, when a UE determines a configuration, the UE may require, receive, derive, acquire, determine, store, apply, and/or use the configuration. A network node may configure the NES UE with the first configuration by a first method. The network node may provide the first configuration to the NES UE by the first method. The network node may configure the legacy UE with the second configuration by a second method. The network node may provide the second configuration to the legacy UE by the second method. The NES UE may determine (or derive) the first configuration by the first method. The NES UE may determine (or apply, or use) a first value for the first configuration. The legacy UE may determine (or derive) the second configuration by the second method. The legacy UE may determine (or apply, or use) a second value for the second configuration.

The first configuration and the second configuration may be (entirely) the same. The first configuration and the second configuration may be (entirely or partially) different. The first configuration may be a subset of the second configuration. That is, the first configuration may include first parameter(s) included in the second configuration, and the first configuration may not include second parameter(s) included in the second configuration, and the first configuration may not include third parameter(s) which are not included in the second configuration. Alternatively and/or additionally, the second configuration may be a subset of the first configuration. The (first and/or second) configuration may be (or include) one or more parameter(s) of (and not limited to): 4-step RA configuration, 2-step RA configuration, contention-based RA configuration, contention-free RA configuration, RA resource configuration, RA preamble configuration, RA preamble group configuration, RACH-ConfigCommon, PRACH configuration, RACH-ConfigCommonTwoStepRA, RACH-ConfigDedicated, RACH-ConfigGeneric, and/or RACH-ConfigGenericTwoStepRA.

The first method and the second method may be different. The first method and the second method may be the same. The method (e.g., the first method, the second method) may be to receive a common signaling (from network). The UE (e.g., NES UE, legacy UE) may receive a common signaling including at least the (first, second) configuration. The UE may apply the (first, second) configuration in response to receiving the common signaling including the (first, second) configuration. The UE may acquire the (first, second) configuration by the common signaling. The (first, second) configuration may be (or include) a cell-specific configuration. The (first, second) configuration may be (or include) a BWP-specific configuration. The (first, second) configuration may be (or include) a configuration common for multiple UEs, a group of UEs and/or a UE group. The common signaling may be (or include) a broadcast signaling. The common signaling may be received by multiple UEs (or a group of UEs), e.g., in a UE group. The common signaling may be (or include) system information. The common signaling may be (or include) paging. The common signaling may be (or include) any of RRC signaling (e.g., RRC configuration message), MAC signaling (e.g., MAC CE), or PHY signaling (e.g., PDCCH, DCI).

Alternatively and/or additionally, the method (e.g., the first method, the second method) may be to receive a dedicated signaling (from network). The UE may receive a dedicated signaling including at least the (first, second) configuration. The UE may apply the (first, second) configuration in response to receiving the dedicated signaling including the (first, second) configuration. The UE may acquire the (first, second) configuration by the dedicated signaling. The (first, second) configuration may be (or include) a UE-specific configuration. The (first, second) configuration may be (or include) a configuration dedicated for a (single) UE.

The UE may acquire the first configuration (for (a BWP of) a cell) and the second configuration (for (the BWP of) the cell) from a same cell (e.g., the cell or a second cell). Alternatively, the UE may acquire the first configuration (for (a BWP of) a cell) and the second configuration (for (the BWP of) the cell) from different cells (e.g., the second configuration is from the cell and the first configuration is from a second cell).

Alternatively and/or additionally, the UE may apply (or use) a pre-configured (or pre-defined, or fixed) value for the (first, second) configuration. The UE may apply (or use) a pre-configured (or pre-defined, or fixed) configuration for the (first, second) configuration. The UE may not receive a signaling including at least the (first, second) configuration. The UE may apply (or use) the (first, second) configuration without receiving a signaling including at least the (first, second) configuration. The signaling may be a common signaling and/or a dedicated signaling.

The first configuration and the second configuration may be for 4-step RA. The first configuration and the second configuration may be for 2-step RA.

A (legacy, NES) UE may be configured with a (first) scaling factor in the (first, second) configuration configured by the network, if (at least) the random access procedure is prioritized (e.g., for the purpose of the random access initialization). The UE may be not configured with a (first) scaling factor in the (first, second) configuration configured by the network, if (at least) the random access procedure is not prioritized. The NES UE may be (always) configured with a second scaling factor in the (first) configuration configured by the network. The legacy UE may not be configured with the second scaling factor. The second scaling factor may be different from the first scaling factor (e.g., in value, purpose). The second scaling factor may be of the same value as the first scaling factor. The NES UE may be configured with both the first scaling factor and the second scaling factor (at the same time) (e.g., the NES UE initiates the random access procedure for Special Cell (SpCell) beam failure recovery).

The scaling parameter (used to derive backoff time for the UE) may be derived from the first scaling factor and/or the second scaling factor. For example, if (at least) the first scaling factor is configured (e.g., in the second configuration) for a legacy UE, (and the second scaling factor is not configured,) the scaling parameter may be the first scaling factor. If (at least) the first scaling factor is not configured for the legacy UE, (and the second scaling factor is not configured,) the scaling parameter may be 1. If (at least) the second scaling factor is configured (e.g., in the first configuration) for an NES UE, (and the first scaling factor is not configured,) the scaling parameter may be the second scaling factor. If (at least) the first scaling factor (e.g., in the first configuration) and the second scaling factor (e.g., in the second configuration) are both configured for the NES UE, the scaling parameter may be the minimum between the first scaling factor and the second scaling factor. Alternatively and/or additionally, if (at least) the first scaling factor and the second scaling factor are both configured for the NES UE, the scaling parameter may be the maximum between the first scaling factor and the second scaling factor. Alternatively and/or additionally, if (at least) the first scaling factor and the second scaling factor are both configured for the NES UE, the scaling parameter may be selected between the first scaling factor and the second scaling factor (e.g., with equal probability or weighted probability). Alternatively and/or additionally, if (at least) the first scaling factor and the second scaling factor are both configured for the NES UE, the scaling parameter may be the first scaling factor. Alternatively and/or additionally, if (at least) the first scaling factor and the second scaling factor are both configured for the NES UE, the scaling parameter may be the second scaling factor. Alternatively and/or additionally, if (at least) the first scaling factor and the second scaling factor are both configured for the NES UE, the scaling parameter may be the multiplication of the first scaling factor and the second scaling factor.

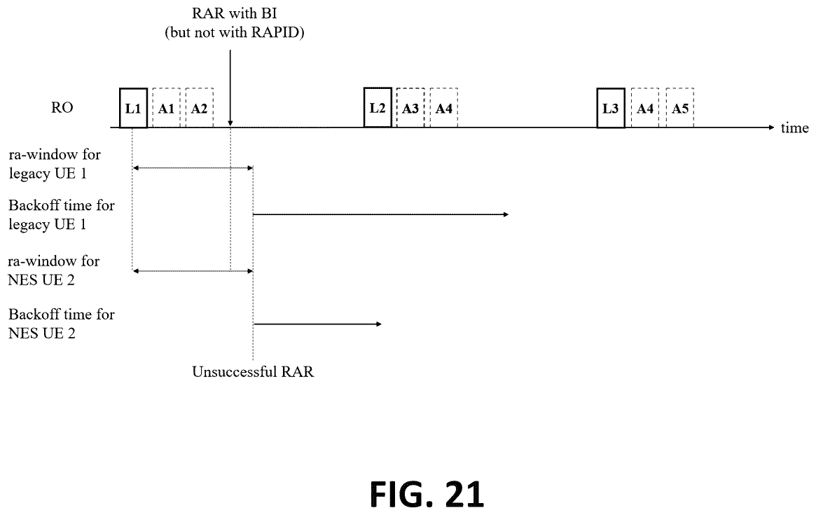

As shown in FIG. 21, a first scaling factor may not be configured (in a second configuration) to a legacy UE (UE1) since the random access (on UE1) is not prioritized. The first scaling factor may not be configured (in a first configuration) to an NES UE (UE2) since the random access (on UE2) is not prioritized. A second scaling factor (smaller than 1) may be configured (in the first configuration) to UE2. UE1 and UE2 may select the same RO (L1) to perform Msg1 transmission. UE1 and UE2 may derive the same RA-RNTI because of the same selected RO (same in time domain, frequency domain and carrier). UE1 and UE2 may start a RA-window after Msg1 transmission, respectively. UE1 and UE2 may receive a RAR corresponding to the RA-RNTI. The RAR may include a backoff indicator and may not include a corresponding RAPID (corresponding to preamble selected by either UE1 or UE2). UE1 may determine a backoff time from a uniform distribution between 0 and the value mapping to the backoff indicator (e.g., multiplied by the default scaling factor 1). UE2 may determine a backoff time from a uniform distribution between 0 and the value mapping to the backoff indicator multiplied by the second scaling factor. Upon the expiry of RA-window, if (at least) UE1 and UE2 does not receive RAR including the corresponding RAPID, and the random access are not completed (for both UE1 and UE2), UE1 and UE2 do not perform Msg1 transmission until each backoff time ends. In this case, the backoff time for UE2 has a higher probability shorter than the backoff time for UE1. Therefore, UE2 may have access to RO earlier (e.g., A3, A4).

A (legacy) UE may receive the second configuration (of RA procedure for (a BWP of) a cell) indicating a second factor. The UE may perform the RA procedure and receive a backoff indicator (in RAR) to indicate a first value. The UE may set PREAMBLE_BACKOFF based on the first value. The UE may set PREAMBLE_BACKOFF to the first value. Alternatively, the UE may set PREAMBLE_BACKOFF based on the first value and the second factor. The UE may set PREAMBLE_BACKOFF to the first value multiplied with the second factor.

A (NES) UE may receive the first configuration (of RA procedure for (a BWP of) a cell) indicating a first factor and the second configuration (of RA procedure for (the BWP of) the cell) indicating the second factor. The UE may perform the RA procedure and receive the backoff indicator (in RAR) to indicate the first value. The UE may set PREAMBLE_BACKOFF based on the first value. The UE may set PREAMBLE_BACKOFF to the first value. Alternatively, the UE may set PREAMBLE_BACKOFF based on the first value and the first factor (e.g., not based on the second factor). The UE may set PREAMBLE_BACKOFF to the first value multiplied with the first factor. Alternatively, the UE may set PREAMBLE_BACKOFF based on the first value and the second factor (e.g., not based on the first factor). The UE may set PREAMBLE_BACKOFF to the first value multiplied with the second factor. Alternatively, the UE may set PREAMBLE_BACKOFF based on the first value, the first factor, and the second factor. The UE may set PREAMBLE_BACKOFF to the first value multiplied with the first factor and multiplied with the second factor. The UE may set PREAMBLE_BACKOFF to the first value multiplied with max(the first factor, the second factor). The UE may set PREAMBLE_BACKOFF to the first value multiplied with min (the first factor, the second factor).

A legacy RO (selected by a first UE, e.g., legacy UE and/or an NES UE) may correspond to a first ID (e.g., RA-RNTI or MSGB-RNTI) (e.g., the ID may be derived from the legacy RO). An additional RO (selected by a second UE, e.g., an NES UE) may correspond to a second ID (e.g., RA-RNTI or MSGB-RNTI). After performing the first transmission, the (legacy, NES) UE may receive and decode a response from the network, if (at least) the ID corresponds to the response. The UE may not decode the response from the network, if (at least) the ID does not correspond to the response. The (first, second) ID may be derived from the following factor(s):
Index of the first Orthogonal Frequency-Division Multiplexing (OFDM) symbol of the PRACH occasion,
Index of the first slot of the PRACH occasion in a system frame,
Index of the PRACH occasion in the frequency domain,
UL carrier used for Random Access Preamble transmission, and/or
Index of whether the RO is additional or legacy.

If (at least) the legacy RO and the additional RO does not overlap in time domain, the index of the first OFDM symbol of the PRACH occasion and the index of the first slot of the PRACH occasion in a system frame may not simultaneously be the same. In this case, the first UE and the second UE may not derive a same ID.

If (at least) the legacy RO and the additional RO does not overlap in frequency domain, the index of the PRACH occasion in the frequency domain may not be the same. In this case, the first UE and the second UE may not derive the same ID.

If (at least) the legacy RO and the additional RO does not locate on the same carrier, the index for UL carrier used for Random Access Preamble transmission may not be the same for the two ROs. In this case, the first UE and the second UE may not derive the same ID.

If (at least) the legacy RO and the additional RO overlap in time domain, frequency domain and carrier, the index of whether the RO is additional or legacy may not be the same for the two ROs. In this case, the first UE and the second UE may not derive the same ID.

For example, the ID may be computed as ID=1+s_id+14×t_id+14×80×f_id+14×80×8×ul_carrier_id+14×80×8×2×type_id+14×80×8×2×2×nes_id, where s_id is the index of the first OFDM symbol of the PRACH occasion (0≤s_id<14), t_id is the index of the first slot of the PRACH occasion in a system frame (0≤t_id<80), where the subcarrier spacing to determine t_id is based on the value of p specified in clause 5.3.2 in TS 38.211 for p=(0, 1, 2, 3), and for p=(5, 6), t_id is the index of the 120 kHz slot in a system frame that contains the PRACH occasion (0≤t_id<80), f_id is the index of the PRACH occasion in the frequency domain (0≤f_id<8), ul_carrier_id is the UL carrier used for Random Access Preamble transmission (0 for NUL carrier, and 1 for SUL carrier), type_id is whether the ID is RA-RNTI or MSGB-RNTI (0 for RA-RNTI, 1 for MSGB-RNTI), and nes_id is the type of selected RO (0 for legacy RO, 1 for additional RO).

A first response (to a first UE which selected the legacy RO) may be received and decoded by the first UE (with the derived corresponding ID). The first response may include a (backoff) field for the first UE. The (backoff) field (included in the first response) may be used to derive the backoff time for the first UE. A second response (to a second UE which selected the additional RO) may be received and decoded by the second UE (with the derived corresponding ID). The second response may include a (backoff) field for the second UE. The (backoff) field (included in the second response) may be used to derive the backoff time for the second UE.

Alternatively and/or additionally, the legacy RO and the additional RO may correspond to a same ID.

The first UE (selecting the legacy RO) and the second UE (selecting the additional RO) may receive and decode a same response for the same ID. The response may include a (backoff) field. The response may indicate to which UE the (backoff) field is for with the subheader (of the subPDU (Protocol Data Unit) of the field). For example, if (at least) the response includes a (backoff) field, and a bit in the subheader of the subPDU of the field is 1, the second UE (selected the additional RO) may apply the value in the (backoff) field (to derive backoff time). The first UE (selected the legacy RO) may not apply the value in the (backoff) field (to derive backoff time). If (at least) the response includes a (backoff) field, and a bit in the subheader of the subPDU of the field is 0, the second UE (selected the additional RO) may not apply the value in the (backoff) field (to derive backoff time). The first UE (selected the legacy RO) may apply the value in the (backoff) field (to derive backoff time).

Alternatively and/or additionally, the response may include more than one (backoff) field. The response may include a third (backoff) field for the first UE (selecting the legacy RO). The response may include a fourth (backoff) field for the second UE (selecting the additional RO). The response may indicate for which UE the field is implicitly. For example, the first field in sequence (in the decoded response) is for a first UE. The second field in sequence (in the decoded response) is for a second UE. The response may indicate for which UE the field is explicitly. For example, the subheader of the subPDU of a third field (for a first UE) may include an indicator bit to be 1. The subheader of the subPDU of a fourth field (for a second UE) may include the indicator bit to be 0.

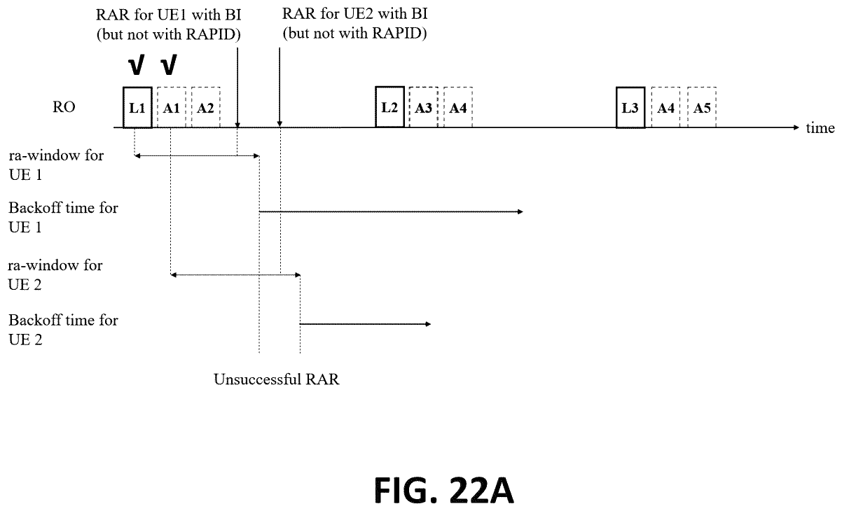

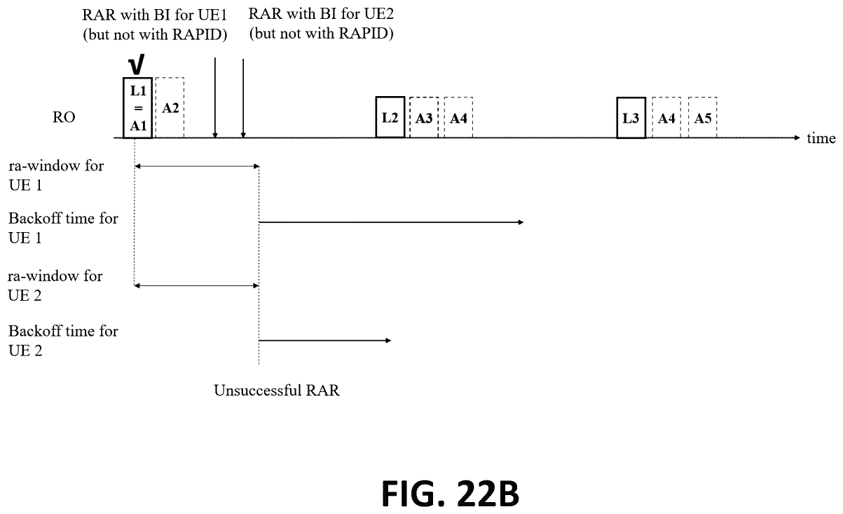

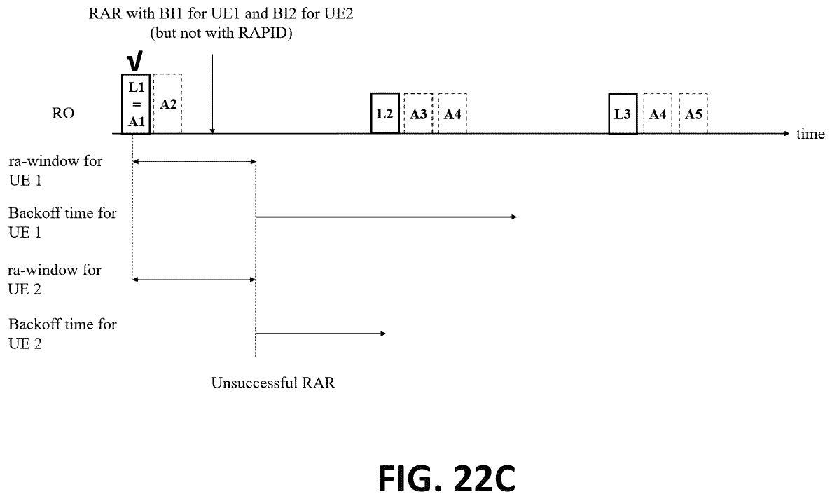

As shown in FIGS. 22A-22C, a first UE (UE1) selects a legacy RO (L1) to perform Msg1 transmission. A second UE (UE2) selects an additional RO (A1) to perform Msg1 transmission. UE1 and UE2 may or may not derive the same RA-RNTI. UE1 and UE2 may start a RA-window after Msg1 transmission, respectively. If UE1 and UE2 derive different RA-RNTIs, UE1 and UE2 may receive different RAR corresponding to each RA-RNTI, as shown in FIG. 22A. Each RAR may include a BI field and may not include a corresponding RAPID (corresponding to preamble selected by the UE). The BI field in each RAR may indicate different backoff parameters. If UE1 and UE2 derive the same RA-RNTI, UE1 and UE2 may receive the same RAR corresponding to the RA-RNTI. The RAR may include (one or more) BI fields and may not include a corresponding RAPID (corresponding to preamble selected by either UE1 or UE2), as shown in FIG. 22B and FIG. 22C. A first BI field (BI1) may be indicated to UE2 with the subheader of the subPDU including an indicator bit to be 1. A second BI field (BI2) may be indicated to UE1 with the subheader of the subPDU including an indicator bit to be 0. UE1 may determine a backoff time from a uniform distribution between 0 and the value mapping to the backoff indicator (derived from BI1) multiplied by the configured scaling factor. UE2 may determine a backoff time from a uniform distribution between 0 and the value mapping to the backoff indicator (derived from BI2) multiplied by the configured scaling factor. Upon the expiry of the RA-window, if (at least) UE1 and UE2 do not receive RAR including the corresponding RAPID, and the random access are not completed (for both UE1 and UE2), UE1 and UE2 do not perform Msg1 transmission until each backoff time ends. In this case, the backoff time for UE2 has a higher probability shorter than the backoff time for UE1. Therefore, UE2 may have access to RO earlier (e.g., A3, A4).

A (NES) UE may receive the first configuration (of RA procedure for (a BWP of) a cell) indicating a first set of ROs and the second configuration (of RA procedure for (the BWP of) the cell) indicating a second set of ROs. The UE may transmit an RA preamble via a first RO during the RA procedure. (In response to transmission of the RA preamble,) the UE may receive a backoff indicator (in RAR) to indicate a first value. The UE may set PREAMBLE_BACKOFF based on the first value (and the first factor and/or the second factor). The UE may select a (random) backoff time based on the PREAMBLE_BACKOFF.

The UE may be allowed to perform the Random Access Resource selection procedure to select an RO from the first set after the backoff time when or if (at least) the first RO is from the first set. The UE may not be allowed to perform the Random Access Resource selection procedure to select an RO from the first set during the backoff time when or if (at least) the first RO is from the first set. The UE may be allowed to perform the Random Access Resource selection procedure to select an RO from the second set during the backoff time when or if (at least) the first RO is from the first set. The UE may be allowed to perform the Random Access Resource selection procedure to select an RO from the second set after the backoff time when or if (at least) the first RO is from the second set. The UE may not be allowed to perform the Random Access Resource selection procedure to select an RO from the second set during the backoff time when or if (at least) the first RO is from the second set. The UE may be allowed to perform the Random Access Resource selection procedure to select an RO from the first set during the backoff time when or if (at least) the first RO is from the second set.

The UE may receive an indication (in the RAR) to indicate (at least) whether the backoff indicator is associated with the first set or the second set. The UE may be allowed to perform the Random Access Resource selection procedure to select an RO from the first set after the backoff time when or if (at least) the indication or the backoff indicator is associated with the first set. The UE may not be allowed to perform the Random Access Resource selection procedure to select an RO from the first set during the backoff time when or if (at least) the indication or the backoff indicator is associated with the first set. The UE may be allowed to perform the Random Access Resource selection procedure to select an RO from the second set during the backoff time when or if (at least) the indication or the backoff indicator is associated with the first set. The UE may be allowed to perform the Random Access Resource selection procedure to select an RO from the second set after the backoff time when or if (at least) the indication or the backoff indicator is associated with the second set. The UE may not be allowed to perform the Random Access Resource selection procedure to select an RO from the second set during the backoff time when or if (at least) the indication or the backoff indicator is associated with the second set. The UE may be allowed to perform the Random Access Resource selection procedure to select an RO from the first set during the backoff time when or if (at least) the indication or the backoff indicator is associated with the second set.

The UE may receive an indication (in the RAR) to indicate (at least) the backoff indicator is associated with the first set. The UE may receive a second backoff indicator (in the RAR) to indicate a second value. The UE may set a second PREAMBLE_BACKOFF based on the second value (and the first factor and/or the second factor). The UE may select a second (random) backoff time based on the second PREAMBLE_BACKOFF. The UE may receive a second indication (in the RAR) to indicate (at least) the second backoff indicator is associated with the second set. The UE may be allowed to perform the Random Access Resource selection procedure to select an RO from the first set after the backoff time. The UE may not be allowed to perform the Random Access Resource selection procedure to select an RO from the first set during the backoff time. The UE may be allowed to perform the Random Access Resource selection procedure to select an RO from the second set after the second backoff time. The UE may not be allowed to perform the Random Access Resource selection procedure to select an RO from the second set during the second backoff time.

One or more of above embodiment(s), concept(s), method(s), example(s), and/or case(s) for the backoff time could be combined, in whole or in part.

Various examples and embodiments of the present invention are described below. For the methods, alternatives, concepts, examples, and embodiments detailed above and herein, the following aspects and embodiments are possible.

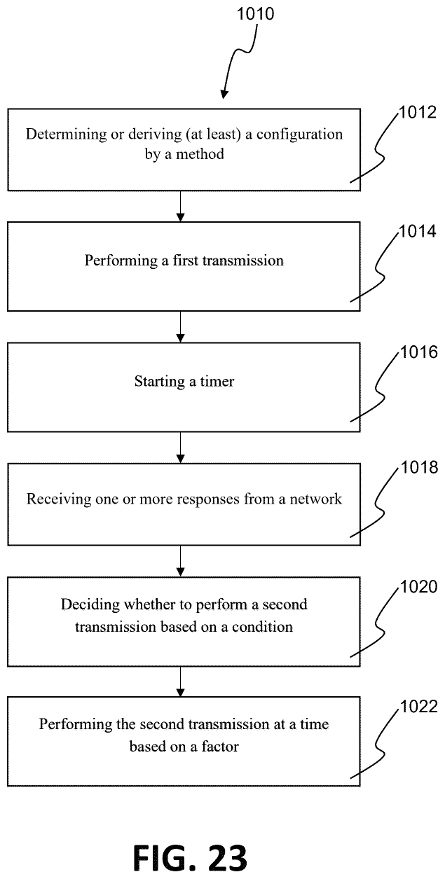

Referring to FIG. 23, with this and other concepts, systems, and methods of the present invention, a method 1010 for a UE in a wireless communication system comprises determining or deriving (at least) a configuration by a method (step 1012), performing a first transmission (step 1014), starting a timer (step 1016), receiving one or more responses from a network (step 1018), deciding whether to perform a second transmission based on a condition (step 1020), and performing the second transmission at a time based on a factor (step 1022).

In various embodiments, the UE is an NES-capable UE.

In various embodiments, the UE determines or derives a value for the configuration.

In various embodiments, the configuration includes a configuration related to RA.

In various embodiments, the configuration includes a parameter related to scaling factor.

In various embodiments, the method is to receive a common signaling from a network node.

In various embodiments, the method is to receive a dedicated signaling from a network node.

In various embodiments, the first transmission is a Msg1 or MSGA.

In various embodiments, the timer is a ra-Response Window or msgB-Response Window.

In various embodiments, the one or more responses is a RAR.

In various embodiments, the one or more responses includes a BI.

In various embodiments, the condition includes that the response does not include an ID corresponding to a resource for the first transmission upon the expiry of the timer.

In various embodiments, the ID is a RAPID.

In various embodiments, the resource is a preamble.

In various embodiments, the second transmission is a Msg1 or MSGA.

In various embodiments, the factor includes the scaling factor.

In various embodiments, the factor includes the value mapped to the BI.

In various embodiments, the time is a selected from a uniform distribution between 0 and the value mapped to BI, multiplied by the scaling factor.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) determine or derive (at least) a configuration by a method; (ii) perform a first transmission; (iii) start a timer; (iv) receive one or more responses from a network; (v) decide whether to perform a second transmission based on a condition; and (vi) perform the second transmission at a time based on a factor. Moreover, the CPU 308 can execute the program code 312 to perform all of the described actions, steps, and methods described above, below, or otherwise herein.

Referring back to FIGS. 3 and 4, in one or more embodiments from the perspective of a NW in a wireless communication system, the device 300 includes a program code 312 stored in memory 310 of the transmitter. The CPU 308 could execute program code 312 to: (i) determine or derive, at a UE, (at least) a configuration by a method; (ii) perform, at the UE, a first transmission; (iii) start a timer at the UE; (iv) transmit one or more responses to the UE; (v) decide, at the UE, whether to perform a second transmission based on a condition; and (vi) perform the second transmission at a time based on a factor. Moreover, the CPU 308 can execute the program code 312 to perform all of the described actions, steps, and methods described above, below, or otherwise herein.

Various examples and embodiments of the present invention are described below. For the methods, alternatives, concepts, examples, and embodiments detailed above and herein, the following aspects and embodiments are possible.

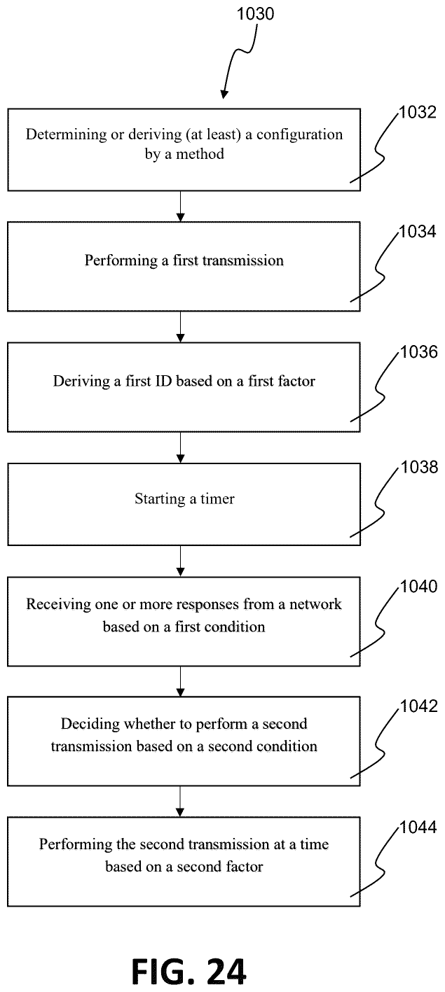

Referring to FIG. 24, with this and other concepts, systems, and methods of the present invention, a method 1030 for a UE in a wireless communication system comprises determining or deriving (at least) a configuration by a method (step 1032), performing a first transmission (step 1034), deriving a first ID based on a first factor (step 1036), starting a timer (step 1038), receiving one or more responses from a network based on a first condition (step 1040), deciding whether to perform a second transmission based on a second condition (step 1042), and performing the second transmission at a time based on a second factor (step 1044).

In various embodiments, the UE is an NES-capable UE.

In various embodiments, the UE determines or derives a value for the configuration.

In various embodiments, the configuration includes a configuration related to RA.

In various embodiments, the method is to receive a common signaling from a network node.

In various embodiments, the method is to receive a dedicated signaling from a network node.

In various embodiments, the first transmission is a Msg1 or MSGA.

In various embodiments, the first transmission is starting on an RO.

In various embodiments, the first ID is an RA-RNTI or MSGB-RNTI.

In various embodiments, the first factor is the time domain of the RO for the first transmission.

In various embodiments, the first factor is the frequency domain of the RO for the first transmission.

In various embodiments, the first factor is the UL carrier of the RO for the first transmission.

In various embodiments, the first factor is the type of the first ID.

In various embodiments, the first factor is the type of the RO for the first transmission.

In various embodiments, the timer is a ra-Response Window or msgB-Response Window.

In various embodiments, the one or more responses is a RAR.

In various embodiments, the one or more responses includes one or more BI fields.

In various embodiments, the BI field has an indicator in the subheader of its subPDU indicating the UE to apply a value mapped to the BI field.

In various embodiments, the condition includes that the response does not include a RAPID corresponding to the preamble for the first transmission.

In various embodiments, the second transmission is a Msg1 or MSGA.

In various embodiments, the factor includes the value mapped to the BI.

In various embodiments, the factor includes a scaling factor in the configuration.

In various embodiments, the time is a selected from a uniform distribution between 0 and the value mapped to BI, multiplied by the scaling factor.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) determine or derive (at least) a configuration by a method; (ii) perform a first transmission; (iii) derive a first ID based on a first factor; (iv) start a timer; (v) receive one or more responses from a network based on a first condition; (vi) decide whether to perform a second transmission based on a second condition; and (vii) perform the second transmission at a time based on a second factor. Moreover, the CPU 308 can execute the program code 312 to perform all of the described actions, steps, and methods described above, below, or otherwise herein.

Referring back to FIGS. 3 and 4, in one or more embodiments from the perspective of a NW in a wireless communication system, the device 300 includes a program code 312 stored in memory 310 of the transmitter. The CPU 308 could execute program code 312 to: (i) determine or derive, at a UE, (at least) a configuration by a method; (ii) perform a first transmission at the UE; (iii) derive, at the UE, a first ID based on a first factor; (iv) start a timer at the UE; (v) transmit one or more responses to the UE based on a first condition; (vi) decide, at the UE, whether to perform a second transmission based on a second condition; and (vii) perform, at the UE, the second transmission at a time based on a second factor. Moreover, the CPU 308 can execute the program code 312 to perform all of the described actions, steps, and methods described above, below, or otherwise herein.

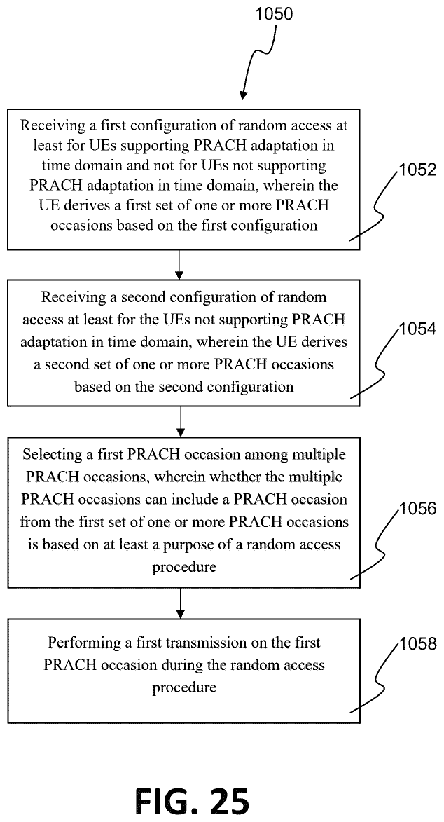

Referring to FIG. 25, with this and other concepts, systems, and methods of the present invention, a method 1050 for a UE in a wireless communication system comprises receiving a first configuration of random access at least for UEs supporting PRACH adaptation in time domain and not for UEs not supporting PRACH adaptation in time domain, wherein the UE derives a first set of one or more PRACH occasions based on the first configuration (step 1052), receiving a second configuration of random access at least for the UEs not supporting PRACH adaptation in time domain, wherein the UE derives a second set of one or more PRACH occasions based on the second configuration (step 1054), selecting a first PRACH occasion among multiple PRACH occasions, wherein whether the multiple PRACH occasions can include a PRACH occasion from the first set of one or more PRACH occasions is based on at least a purpose of a random access procedure (step 1056), and performing a first transmission on the first PRACH occasion during the random access procedure (step 1058).

In various embodiments, the multiple PRACH occasions do not or cannot include a PRACH occasion from the first set of one or more PRACH occasions when the purpose is system information request.

In various embodiments, the multiple PRACH occasions includes PRACH occasions from the second set of one or more PRACH occasions when the purpose is system information request.

In various embodiments, the UE does not select the first PRACH occasion among PRACH occasions from the first set of one or more PRACH occasions when the purpose is system information request.

In various embodiments, the UE selects the first PRACH occasion among PRACH occasions from the second set of one or more PRACH occasions when the purpose is system information request.

In various embodiments, the multiple PRACH occasions can include a PRACH occasion from the first set of one or more PRACH occasions when the purpose is for initial access or Uplink (UL) data arrival.

In various embodiments, the multiple PRACH occasions can include a PRACH occasion from the second set of one or more PRACH occasions when the purpose is for initial access or UL data arrival.

In various embodiments, the UE selects the first PRACH occasion among PRACH occasions from the first set of one or more PRACH occasions and the second set of one or more PRACH occasions, when the purpose is for initial access or UL data arrival.

In various embodiments, the second configuration is (also) for UEs supporting PRACH adaptation in time domain.

In various embodiments, the first configuration is for NES-capable UEs.

In various embodiments, the first transmission is a Msg1 and/or a MSGA.

In various embodiments, the UE selects the first PRACH occasion randomly with equal probability among the multiple PRACH occasions.

In various embodiments, the first configuration and the second configuration are included in system information.

In various embodiments, the UEs supporting PRACH adaptation in time domain are NES-capable UEs.

In various embodiments, the UEs not supporting PRACH adaptation in time domain are non-NES-capable UEs and/or legacy UEs.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a first configuration of random access at least for UEs supporting PRACH adaptation in time domain and not for UEs not supporting PRACH adaptation in time domain, wherein the UE derives a first set of one or more PRACH occasions based on the first configuration; (ii) receive a second configuration of random access at least for the UEs not supporting PRACH adaptation in time domain, wherein the UE derives a second set of one or more PRACH occasions based on the second configuration; (iii) select a first PRACH occasion among multiple PRACH occasions, wherein whether the multiple PRACH occasions can include a PRACH occasion from the first set of one or more PRACH occasions is based on at least a purpose of a random access procedure; and (iv) perform a first transmission on the first PRACH occasion during the random access procedure. Moreover, the CPU 308 can execute the program code 312 to perform all of the described actions, steps, and methods described above, below, or otherwise herein.

Referring back to FIGS. 3 and 4, in one or more embodiments from the perspective of a NW in a wireless communication system, the device 300 includes a program code 312 stored in memory 310 of the transmitter. The CPU 308 could execute program code 312 to: (i) transmit, to a UE, a first configuration of random access at least for UEs supporting PRACH adaptation in time domain and not for UEs not supporting PRACH adaptation in time domain, wherein a first set of one or more PRACH occasions is derived based on the first configuration; (ii) transmit, to the UE, a second configuration of random access at least for the UEs not supporting PRACH adaptation in time domain, wherein a second set of one or more PRACH occasions is derived based on the second configuration; and (iii) receive, from the UE, a first transmission on a first PRACH occasion among multiple PRACH occasions during a random access procedure, wherein whether the multiple PRACH occasions can include a PRACH occasion from the first set of one or more PRACH occasions is based on at least a purpose of the random access procedure. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a User Equipment (UE), comprising:
receiving a first configuration of random access at least for UEs supporting Physical Random Access Channel (PRACH) adaptation in time domain and not for UEs not supporting PRACH adaptation in time domain, wherein the UE derives a first set of one or more PRACH occasions based on the first configuration;
receiving a second configuration of random access at least for the UEs not supporting PRACH adaptation in time domain, wherein the UE derives a second set of one or more PRACH occasions based on the second configuration;
selecting a first PRACH occasion among multiple PRACH occasions, wherein whether the multiple PRACH occasions can include a PRACH occasion from the first set of one or more PRACH occasions is based on at least a purpose of a random access procedure; and
performing a first transmission on the first PRACH occasion during the random access procedure.

2. The method of claim 1, wherein the multiple PRACH occasions do not or cannot include a PRACH occasion from the first set of one or more PRACH occasions when the purpose is system information request.

3. The method of claim 1, wherein the multiple PRACH occasions includes PRACH occasions from the second set of one or more PRACH occasions when the purpose is system information request.

4. The method of claim 1, wherein the UE does not select the first PRACH occasion among PRACH occasions from the first set of one or more PRACH occasions when the purpose is system information request.

5. The method of claim 1, wherein the UE selects the first PRACH occasion among PRACH occasions from the second set of one or more PRACH occasions when the purpose is system information request.

6. The method of claim 1, wherein the multiple PRACH occasions can include a PRACH occasion from the first set of one or more PRACH occasions when the purpose is for initial access or Uplink (UL) data arrival.

7. The method of claim 1, wherein the multiple PRACH occasions can include a PRACH occasion from the second set of one or more PRACH occasions when the purpose is for initial access or UL data arrival.

8. The method of claim 1, wherein the UE selects the first PRACH occasion among PRACH occasions from the first set of one or more PRACH occasions and the second set of one or more PRACH occasions, when the purpose is for initial access or UL data arrival.

9. The method of claim 1, wherein the second configuration is also for the UEs supporting PRACH adaptation in time domain.

10. The method of claim 1, wherein the first transmission is a Msg1 and/or a MSGA.

11. The method of claim 1, wherein the UE selects the first PRACH occasion randomly with equal probability among the multiple PRACH occasions.

12. The method of claim 1, wherein the first configuration and the second configuration are included in system information.

13. The method of claim 1, wherein the UEs supporting PRACH adaptation in time domain are Network Energy Saving (NES)-capable UEs, and/or the UEs not supporting PRACH adaptation in time domain are non-NES-capable UEs and/or legacy UEs.

14. A User Equipment (UE), comprising:
a memory; and
a processor operatively coupled with the memory, wherein the processor is configured to execute a program code to:
receive a first configuration of random access at least for UEs supporting Physical Random Access Channel (PRACH) adaptation in time domain and not for UEs not supporting PRACH adaptation in time domain, wherein the UE derives a first set of one or more PRACH occasions based on the first configuration;
receive a second configuration of random access at least for the UEs not supporting PRACH adaptation in time domain, wherein the UE derives a second set of one or more PRACH occasions based on the second configuration;
select a first PRACH occasion among multiple PRACH occasions, wherein whether the multiple PRACH occasions can include a PRACH occasion from the first set of one or more PRACH occasions is based on at least a purpose of a random access procedure; and
perform a first transmission on the first PRACH occasion during the random access procedure.

15. The UE of claim 14, wherein the multiple PRACH occasions do not or cannot include a PRACH occasion from the first set of one or more PRACH occasions when the purpose is system information request.

16. The UE of claim 14, wherein the multiple PRACH occasions includes PRACH occasions from the second set of one or more PRACH occasions when the purpose is system information request.

17. The UE of claim 14, wherein the UE does not select the first PRACH occasion among PRACH occasions from the first set of one or more PRACH occasions when the purpose is system information request.

18. The UE of claim 14, wherein the UE selects the first PRACH occasion among PRACH occasions from the second set of one or more PRACH occasions when the purpose is system information request.

19. The UE of claim 14, wherein the multiple PRACH occasions can include a PRACH occasion from the first set of one or more PRACH occasions when the purpose is for initial access or Uplink (UL) data arrival, and/or the multiple PRACH occasions can include a PRACH occasion from the second set of one or more PRACH occasions when the purpose is for initial access or UL data arrival.

20. The UE of claim 14, wherein the UE selects the first PRACH occasion among PRACH occasions from the first set of one or more PRACH occasions and the second set of one or more PRACH occasions, when the purpose is for initial access or UL data arrival.
